(19) United States
(12) Patent Application Publication
(10) Pub. No.: US 2010/0233554 A1
(43) Pub. Date: Sep. 16, 2010

(54) FUEL CELL SYSTEM AND OPERATING METHOD THEREOF

(76) Inventors: Atsushi Nogi, Osaka (JP); Soichi Shibata, Osaka (JP); Aoi Muta, Osaka (JP); Yoichiro Tsuji, Osaka (JP); Kazuhito Hatoh, Osaka (JP)

Correspondence Address: MCDERMOTT WILL & EMERY LLP, 600 13TH STREET, NW, WASHINGTON, DC, 20005-3096, US

(21) Appl. No.: 12/161,260

(22) PCT Filed: Jan. 16, 2007
(86) PCT No.: PCT/JP2007/050480

§ 371 Date: Jul. 17, 2008

(30) Foreign Application Priority Data
Jan. 17, 2006 (JP) 2006-008169

(51) Int. Cl. H01M 8/04; H01M 8/10

(52) U.S. Cl. 429/428; 429/483

(57) ABSTRACT

A fuel cell system of the present invention includes: a polymer electrolyte fuel cell (1) including an MEA (12) having a polymer electrolyte membrane (13), an anode (16a) and a cathode (16b); a fuel gas supplying device (4) which supplies a fuel gas to the anode (16a); an oxidizing gas supplying device (5) which supplies an oxidizing gas to the cathode (16b); a moisture flow rate detector (2) which detects at least one of a flow rate of moisture discharged from the cathode (16b) and a flow rate of moisture discharged from the anode (16a); storage means (22) for storing a reference moisture flow rate that is the moisture flow rate at the time of a reference output of the polymer electrolyte fuel cell (1); and an anode oxidizer (25) which compares the moisture flow rate detected by the moisture flow rate detector (2) with the reference moisture flow rate stored in the storage means (22) and oxidizes the anode (16a) based on a result of the comparison.

### TECHNICAL FIELD

The present invention relates to a fuel cell system and an operating method thereof, and more particularly to a fuel cell system which mounts a polymer electrolyte fuel cell as a fuel cell, and an operating method thereof.

### BACKGROUND ART

A polymer electrolyte fuel cell is a fuel cell configured to carry out an electrochemical reaction (oxidation-reduction reaction) between a fuel gas which is obtained by reforming a material gas, such as a city gas, and contains hydrogen and an oxidizing gas containing oxygen, such as air, to take out electrons to be supplied to an external circuit. A unit cell (cell) of the fuel cell includes an MEA (polymer electrolyte membrane-electrode assembly) having a polymer electrolyte membrane and a pair of gas diffusion electrodes (anode and cathode), gaskets, and electrically-conductive separators. Each separator includes, on its surface contacting the gas diffusion electrode, a gas passage through which a fuel gas or an oxidizing gas (each of these gases is called a “reactant gas”) flows. The separators sandwich the MEA on a peripheral portion of which the gaskets are disposed. Thus, a cell is formed.

In accordance with such fuel cell, since a voltage obtained from the cell is low, the cells are stacked and fastened to each other and adjacent MEAs are electrically connected to one another in series to obtain a necessary output voltage.

Examples of decreases in cell performance during the operation of the polymer electrolyte fuel cell are material deterioration of a catalyst constituting the gas diffusion electrode due to mixing of an impurity, preventing of transmission of the reactant gas toward the gas diffusion electrode due to the progress of flooding in the gas passage, and damaging of the cell due to, for example, occurrence of cross leakage of the reactant gas. By detecting, predicting and appropriately dealing with these deteriorations, it becomes possible to extend a cell life.

Among the above deteriorations, the decrease in cell performance due to the mixing of the impurity is important since the cell performance can be restored by removing the impurity. Regarding the mixing of the impurity, there may be a case where the impurity mixed into the reactant gas gets into the fuel cell from the outside and a case where the impurity is generated inside the fuel cell due to residues at the time of producing the fuel cell, thermal decomposition of members constituting the fuel cell at the time of the operation of the fuel cell, and/or the like. The impurity is adhered to the catalyst, the gas diffusion layer, and/or the like. This interrupts the diffusion and reaction of the reactant gas. As a result, the cell performance decreases.

Known as a method for restoring the fuel cell whose performance is decreased by the impurity adhered to the gas diffusion electrode is an operation control method for operating and controlling the fuel cell such that a potential of a fuel electrode (anode) is increased to be equal to or higher than a potential at which a poisoning component (impurity) adsorbed to the fuel electrode is electrochemically oxidized (see Patent Document 1 for example). Patent Document 1 discloses that as means for detecting the decrease in performance of the fuel cell, a hydrogen electrode reference potential sensor for measuring the potential of the fuel electrode or a voltage sensor for measuring the voltage of the fuel cell is disposed.

Patent Document 2 discloses a fuel cell stack in which a voltage measuring terminal is disposed on a separator to measure the voltage of each cell.

With these, by increasing the potential of the fuel electrode, it is possible to restore the fuel cell whose performance is decreased by the impurity adhered to the electrode.

Patent Document 1: Japanese Patent Publication No. 3536645

Patent Document 2: Japanese Laid-Open Patent Application Publication No. Hei. 11-339828

### DISCLOSURE OF THE INVENTION

### Problems to be Solved by the Invention

In the fuel cell stack disclosed in Patent Document 2, the voltage is measured as a relative difference between the anode and the cathode. Therefore, in a case where the voltage is abnormal, it is impossible to specify that the cause of the abnormality is deterioration of the cathode, deterioration of the anode, flooding, or cross leakage. Thus, there is still room for improvement.

Moreover, in accordance with the operation control method disclosed in Patent Document 1, the voltage is simply measured as a relative difference between the anode and the cathode. Therefore, even in a case where the voltage is abnormal even though the impurity is not mixed into the anode, the operation control method increases the potential of the anode. On this account, there is a problem that the abnormal voltage causes the material deterioration of the catalyst contained in the anode.

The present invention was made to solve the above problems, and an object of the present invention is to provide a fuel cell system capable of surely restoring the performance of an anode thereof at such a timing that the performance of a fuel cell thereof needs to be restored, and a method for operating the fuel cell system.

### Means for Solving the Problems

As a result of diligent studies to achieve the above object, the present inventors have found that there is a relation between a flow rate of water discharged at the time of a reference output of the fuel cell and a flow rate of water discharged when the anode is poisoned by the impurity, and this is extremely significant to achieve the object of the present invention. Thus, the present inventors have achieved the present invention.

To be specific, in order to solve the above problems, a fuel cell system according to the present invention includes: a polymer electrolyte fuel cell configured to include an MEA having a polymer electrolyte membrane and an anode and a cathode which sandwich the polymer electrolyte membrane, to cause the anode to be supplied with a fuel gas and the cathode to be supplied with an oxidizing gas, to cause the supplied fuel gas and the supplied oxidizing gas to react to generate electric power, to discharge an unreacted fuel gas from the anode, and to discharge an unreacted oxidizing gas from the cathode; a fuel gas supplying device which supplies the fuel gas to the anode; an oxidizing gas supplying device which supplies the oxidizing gas to the cathode; a moisture flow rate detector which detects at least one of a flow rate of moisture discharged from the cathode and a flow rate of moisture discharged from the anode (flow rate of moisture is hereinafter referred to as “moisture flow rate”); storage means for storing a reference moisture flow rate that is the moisture flow rate at the time of a reference output of the polymer electrolyte fuel cell; and an anode oxidizer which compares the moisture flow rate detected by the moisture flow rate detector with the reference moisture flow rate stored in the storage means and oxidizes the anode based on a result of the comparison.

With this, the moisture flow rate is detected by the moisture flow rate detector, the detected moisture flow rate and the reference moisture flow rate that is the flow rate at the time of the reference output in which the anode is not poisoned are compared, and then the anode is oxidized. Therefore, the anode can be oxidized only at such an appropriate timing that the anode is poisoned by the impurity, and the performance of the fuel cell can be restored while minimizing the deterioration of the anode by the oxidation.

In the case of the operation control method of Patent Document 1, in order to dispose the hydrogen electrode reference potential sensor, a configuration for connecting the hydrogen electrode reference potential sensor and the anode by an ion conduction passage is additionally required (for example, it is necessary to join the hydrogen electrode reference potential sensor to a polymer electrolyte membrane to which the anode has been joined). Moreover, in the case of the operation control method, in order to maintain a reference potential of the hydrogen electrode reference potential sensor, it is necessary that the hydrogen electrode reference potential sensor is not poisoned by, for example, CO. Therefore, it is necessary to use a bomb of pure hydrogen or to use a device which removes CO and CO₂ from the reformed fuel gas to refine the pure hydrogen. Further, in this case, a passage for supplying hydrogen to the hydrogen electrode reference potential sensor needs to be provided separately from a passage for supplying the fuel gas to the anode. As above, introducing the hydrogen electrode reference potential sensor to the fuel cell system as in the technique described in Patent Document 1 is very difficult in light of the cost and labor.

Therefore, in the case of the configuration of the present invention, since the poisoning of the anode can be detected without disposing the hydrogen electrode reference potential sensor at the anode, it is possible to reduce an cost increase of the fuel cell system and complexity of manufacturing steps, which are caused by disposing the hydrogen electrode reference potential sensor, such as by disposing, for example, a device necessary for maintaining the reference potential of the hydrogen electrode reference potential sensor.

Moreover, in the fuel cell system according to the present invention, the anode oxidizer may be configured to oxidize the anode in such a manner that the anode oxidizer controls a potential of the anode to be in a range from 0 to +1.23V with respect to a standard hydrogen electrode.

Moreover, in the fuel cell system according to the present invention, the anode oxidizer may be configured to oxidize the anode in such a manner that the anode oxidizer controls a potential of the anode to be in a range from +0.8 to +1.23V with respect to a standard hydrogen electrode.

Moreover, in the fuel cell system according to the present invention, the anode oxidizer may be configured to oxidize the anode in such a manner that the anode oxidizer controls a potential of the anode to be equal to or higher than a potential at which a poisoning component adsorbed to the anode is electrochemically oxidized.

Moreover, in the fuel cell system according to the present invention, the moisture flow rate detector may be a cathode moisture flow rate detector which detects a cathode moisture flow rate that is the flow rate of moisture discharged from the cathode; the storage means may store a cathode reference moisture flow rate that is the flow rate of moisture discharged from the cathode at the time of the reference output; and the anode oxidizer may be configured to oxidize the anode in a case where the cathode moisture flow rate is higher than the cathode reference moisture flow rate.

With this, since the cathode moisture flow rate detector detects the cathode moisture flow rate, and the anode is oxidized in a case where the detected cathode moisture flow rate is higher than the cathode reference moisture flow rate that is the flow rate at the time of the reference output in which the anode is not poisoned, it is possible to surely detect the poisoning of the anode by the impurity.

Moreover, in the fuel cell system according to the present invention, the moisture flow rate detector may be an anode moisture flow rate detector which detects an anode moisture flow rate that is the flow rate of moisture discharged from the anode; the storage means may store an anode reference moisture flow rate that is the flow rate of moisture discharged from the anode at the time of the reference output; and the anode oxidizer may be configured to oxidize the anode in a case where the anode moisture flow rate is lower than the anode reference moisture flow rate.

With this, since the anode moisture flow rate detector measures the anode moisture flow rate, and the anode is oxidized in a case where the anode moisture flow rate is lower than the anode reference moisture flow rate that is the flow rate at the time of the reference output in which the anode is not poisoned, it is possible to surely detect the poisoning of the anode by the impurity.

Moreover, in the fuel cell system according to the present invention, the cathode moisture flow rate detector may be configured to calculate a flow rate of steam from a dew point and flow rate of the oxidizing gas and to detect the cathode moisture flow rate from the calculated flow rate of the steam and a flow rate of water discharged from the cathode.

Moreover, in the fuel cell system according to the present invention, the anode moisture flow rate detector may be configured to calculate a flow rate of steam from a dew point and flow rate of the oxidizing gas and to detect the anode moisture flow rate from the calculated flow rate of the steam and a flow rate of water discharged from the anode.

Moreover, in the fuel cell system according to the present invention, the cathode moisture flow rate detector may be configured to change moisture, discharged from the cathode, into water to detect the cathode moisture flow rate.

Moreover, in the fuel cell system according to the present invention, the anode moisture flow rate detector may be configured to change moisture, discharged from the anode, into water to detect the anode moisture flow rate.

Moreover, in the fuel cell system according to the present invention, the cathode moisture flow rate detector may be configured to change moisture, discharged from the cathode, into steam to detect the cathode moisture flow rate.

Moreover, in the fuel cell system according to the present invention, the anode moisture flow rate detector may be configured to change moisture, discharged from the anode, into steam to detect the anode moisture flow rate.

Moreover, in the fuel cell system according to the present invention, the anode oxidizer may be configured to oxidize the anode in such a manner that the anode oxidizer controls to temporarily decrease a flow rate of the fuel gas supplied from the fuel gas supplying device to the anode, to increase a potential of the anode.

Moreover, in the fuel cell system according to the present invention, the anode oxidizer may include a mixture gas supplying unit for mixing a mixture gas into the fuel gas to be supplied to the anode; and the anode oxidizer may be configured to oxidize the anode in such a manner that the anode oxidizer controls the mixture gas supplying unit to mix the mixture gas into the fuel gas, thereby temporarily decreasing a concentration of a hydrogen gas contained in a gas to be supplied to the anode to increase a potential of the anode.

Moreover, the fuel cell system according to the present invention may further include an electric output device for adjusting an output of the polymer electrolyte fuel cell, wherein the anode oxidizer may be configured to oxidize the anode in such a manner that the anode oxidizer controls to maintain a constant flow rate of the fuel gas to be supplied to the anode and increase an output current density of the electric output device, thereby increasing a potential of the anode.

Moreover, in the fuel cell system according to the present invention, the anode oxidizer may include an air supplying unit which supplies air to the anode; and the anode oxidizer may be configured to oxidize the anode in such a manner that the anode oxidizer controls the air supplying unit to supply the air to the anode, thereby increasing a potential of the anode.

Further, a method for operating a fuel cell system according to the present invention is a method for operating a fuel cell system including: a polymer electrolyte fuel cell configured to include an MEA having a polymer electrolyte membrane and an anode and a cathode which sandwich the polymer electrolyte membrane, to cause the anode to be supplied with a fuel gas and the cathode to be supplied with an oxidizing gas, to cause the supplied fuel gas and the supplied oxidizing gas to react to generate electric power, to discharge an unreacted fuel gas from the anode, and to discharge an unreacted oxidizing gas from the cathode; a fuel gas supplying device which supplies the fuel gas to the anode; an oxidizing gas supplying device which supplies the oxidizing gas to the cathode; a moisture flow rate detector which detects at least one of a flow rate of moisture discharged from the cathode or a flow rate of moisture discharged from the anode (flow rate of moisture is hereinafter referred to as “moisture flow rate”); and storage means for storing a reference moisture flow rate that is the moisture flow rate at the time of a reference output of the polymer electrolyte fuel cell, the method comprising the steps of: comparing the moisture flow rate detected by the moisture flow rate detector with the reference moisture flow rate stored in the storage means and oxidizing the anode based on a result of the comparison.

With this, the moisture flow rate is detected by the moisture flow rate detector, the detected moisture flow rate and the reference moisture flow rate that is the flow rate at the time of the reference output in which the anode is not poisoned are compared, and then the anode is oxidized. Therefore, the anode can be oxidized only at such an appropriate timing that the anode is poisoned by the impurity, and the performance of the fuel cell can be restored while minimizing the deterioration of the anode by the oxidation.

Moreover, the method for operating the fuel cell system according to the present invention may further include the step of oxidizing the anode in a state in which a potential of the anode is in a range from 0 to +1.23V with respect to a standard hydrogen electrode.

Moreover, the method for operating the fuel cell system according to the present invention may further include the step of oxidizing the anode in a state in which a potential of the anode is in a range from +0.8 to +1.23V with respect to a standard hydrogen electrode.

Moreover, the method for operating the fuel cell system according to the present invention may further include the step of oxidizing the anode in a state in which a potential of the anode is equal to or higher than a potential at which a poisoning component adsorbed to the anode is electrochemically oxidized.

Moreover, in the method for operating the fuel cell system according to the present invention, the moisture flow rate detector may be a cathode moisture flow rate detector which detects a cathode moisture flow rate that is the flow rate of moisture discharged from the cathode; and the storage means may store a cathode reference moisture flow rate that is the flow rate of moisture discharged from the cathode at the time of the reference output, and the method may further includes the step of oxidizing the anode in a case where the cathode moisture flow rate is higher than the cathode reference moisture flow rate.

With this, since the cathode moisture flow rate is detected by the cathode moisture flow rate detector, and the anode is oxidized in a case where the detected cathode moisture flow rate is higher than the cathode reference moisture flow rate that is the flow rate at the time of the reference output in which the anode is not poisoned, it is possible to surely detect the poisoning of the anode by the impurity.

Moreover, in the method for operating the fuel cell system according to the present invention, the moisture flow rate detector may be an anode moisture flow rate detector which detects an anode moisture flow rate that is the flow rate of moisture discharged from the anode; and the storage means may store an anode reference moisture flow rate that is the flow rate of moisture discharged from the anode at the time of the reference output, and the method may further include the step of oxidizing the anode in a case where the anode moisture flow rate is lower than the anode reference moisture flow rate.

With this, since the anode moisture flow rate is detected by the anode moisture flow rate detector, and the anode is oxidized in a case where the detected anode moisture flow rate is lower than the anode reference moisture flow rate that is the flow rate at the time of the reference output in which the anode is not poisoned, it is possible to surely detect the poisoning of the anode by the impurity.

Moreover, the method for operating the fuel cell system according to the present invention may further include the step of oxidizing the anode by temporarily decreasing the fuel gas, supplied from the fuel gas supplying device to the anode, to increase a potential of the anode.

Moreover, in the method for operating the fuel cell system according to the present invention, the fuel cell system may further include a mixture gas supplying unit for mixing a mixture gas into the fuel gas to be supplied to the anode, and the method may further include the step of oxidizing the anode by mixing the mixture gas into the fuel gas to temporarily decrease a concentration of a hydrogen gas contained in a gas to be supplied to the anode, thereby increasing a potential of the anode.

Moreover, in the method for operating the fuel cell system according to the present invention, the fuel cell system may further include an electric output device for adjusting an output of the polymer electrolyte fuel cell, and the method may further include the step of oxidizing the anode by maintaining a constant flow rate of the fuel gas to be supplied to the anode and increasing an output current density of the electric output device, thereby increasing a potential of the anode.

Moreover, in the method for operating the fuel cell system according to the present invention, the fuel cell system may further include an air supplying unit which supplies air to the anode, and the method may further include the step of oxidizing the anode by supplying the air from the air supplying device to the anode, thereby increasing a potential of the anode.

### EFFECTS OF THE INVENTION

In accordance with a fuel cell system of the present invention and a method for operating the fuel cell system, the decrease in performance of the fuel cell due to the impurity adhered only to the anode (due to poisoning of the anode) can be detected by measuring one or both of the flow rate of moisture discharged from the cathode and the flow rate of moisture discharged from the anode and comparing the flow rate with a reference moisture flow rate of moisture discharged from the cathode or the anode. Therefore, the performance of the polymer electrolyte fuel cell can be restored while minimizing the deterioration of the anode due to the oxidation.

### BRIEF DESCRIPTION OF THE DRAWINGS

FIG. 1 is a block diagram schematically showing the configuration of an entire fuel cell system according to Embodiment 1 of the present invention.

FIG. 2 is a perspective view showing the configuration of a polymer electrolyte fuel cell mounted on the fuel cell system shown in FIG. 1.

FIG. 3 is a schematic diagram showing the configuration of a moisture flow rate detector of the fuel cell system shown in FIG. 1.

FIG. 4 is a flow chart schematically showing a content of an anode potential adjustment operation program stored in a control device of FIG. 1.

FIG. 5 is a schematic diagram showing a modification example of the moisture flow rate detector of the fuel cell system shown in FIG. 3.

FIG. 6 is a schematic diagram showing a modification example of the moisture flow rate detector of the fuel cell system shown in FIG. 3.

FIG. 7 is a block diagram schematically showing the configuration of a modification example of the entire fuel cell system shown in FIG. 1.

FIG. 8 is a block diagram schematically showing the configuration of a modification example of the entire fuel cell system shown in FIG. 1.

FIG. 9 is a graph showing time-lapse changes of a flow ratio of moisture discharged from the polymer electrolyte fuel cell of Example 1 and time-lapse changes of an average cell voltage.

FIG. 10 is a graph showing time-lapse changes of the flow ratio of moisture discharged from the polymer electrolyte fuel cell of Comparative Example 1 and time-lapse changes of the average cell voltage.

FIG. 11 is a cross-sectional view schematically showing the configuration of an MEA of a cell shown in FIG. 2.

FIG. 12 is a schematic diagram showing a modification example of the moisture flow rate detector of the fuel cell system shown in FIG. 3.

FIG. 13 is a graph on which current values by an oxidation-reduction reaction of the anode in Example 2 are plotted.

### EXPLANATION OF REFERENCE NUMBERS

1 polymer electrolyte fuel cell
2 moisture flow rate detector
3 control device
4 fuel gas supplying device
4A mixture gas supplying device
4B air supplying device
5 oxidizing gas supplying device
6 electric output device
7 cooling water supplying device
8 fuel gas supplying passage
9 oxidizing gas supplying passage
10 MEA-gasket assembly
11 gasket
12 MEA
13 oxidizing gas discharging passage
14 fuel gas discharging passage
15 cathode separator
16 gas diffusion electrode
16a anode
16b cathode
17 gas diffusion layer
17a anode gas diffusion layer
17b cathode gas diffusion layer
18 catalyst reaction layer
18a anode catalyst layer
18b cathode catalyst layer
19 polymer electrolyte membrane
20 anode separator
21 calculation control section
22 storage section
23 input section
24 display section
25 anode oxidation treatment section
26 anode oxidizer
27 moisture flow rate calculating section
28a anode moisture flow rate measuring device
28b cathode moisture flow rate measuring device
30A oxidizing gas supplying manifold hole
30B oxidizing gas supplying manifold hole
30C oxidizing gas supplying manifold hole
31 gas passage
32 oxidizing gas supplying manifold
33 oxidizing gas supplying pipe
35A oxidizing gas discharging manifold hole
35B oxidizing gas discharging manifold hole
35C oxidizing gas discharging manifold hole
36 oxidizing gas discharging manifold
37 oxidizing gas discharging pipe
40A fuel gas supplying manifold hole
40B fuel gas supplying manifold hole
40C fuel gas supplying manifold hole
41 gas passage
42 fuel gas supplying manifold
43 fuel gas supplying pipe
45A fuel gas discharging manifold hole
45B fuel gas discharging manifold hole
45C fuel gas discharging manifold hole
46 fuel gas discharging manifold
47 fuel gas discharging pipe
50A cooling water supplying manifold hole
50B cooling water supplying manifold hole
50C cooling water supplying manifold hole
52 cooling water supplying manifold
53 cooling water supplying pipe
54 cooling water supplying passage
55A cooling water discharging manifold hole
55B cooling water discharging manifold hole
55C cooling water discharging manifold hole
56 cooling water discharging manifold
57 cooling water discharging pipe
58 cooling water discharging passage
61 U pipe
62 detector pipe
63 flow rate detecting device (impeller flow meter)
63a impeller section
63b detecting section
64 measuring container pipe
65 measuring container
66 discharge valve
67 discharge pipe
68 condensed water tank pipe
69 weighing machine
70 heat exchanger
71 gas flow meter
72 dew point meter
73 flowmeter
91 mixture gas supplying passage
92 air supplying passage
100 cell
200 fuel cell system

### BEST MODE FOR CARRYING OUT THE INVENTION

Hereinafter, preferred embodiments of the present invention will be explained in reference to the drawings. In the following explanation, same reference numbers are used for the same or corresponding members, and a repetition of the same explanation is avoided.

### Embodiment 1

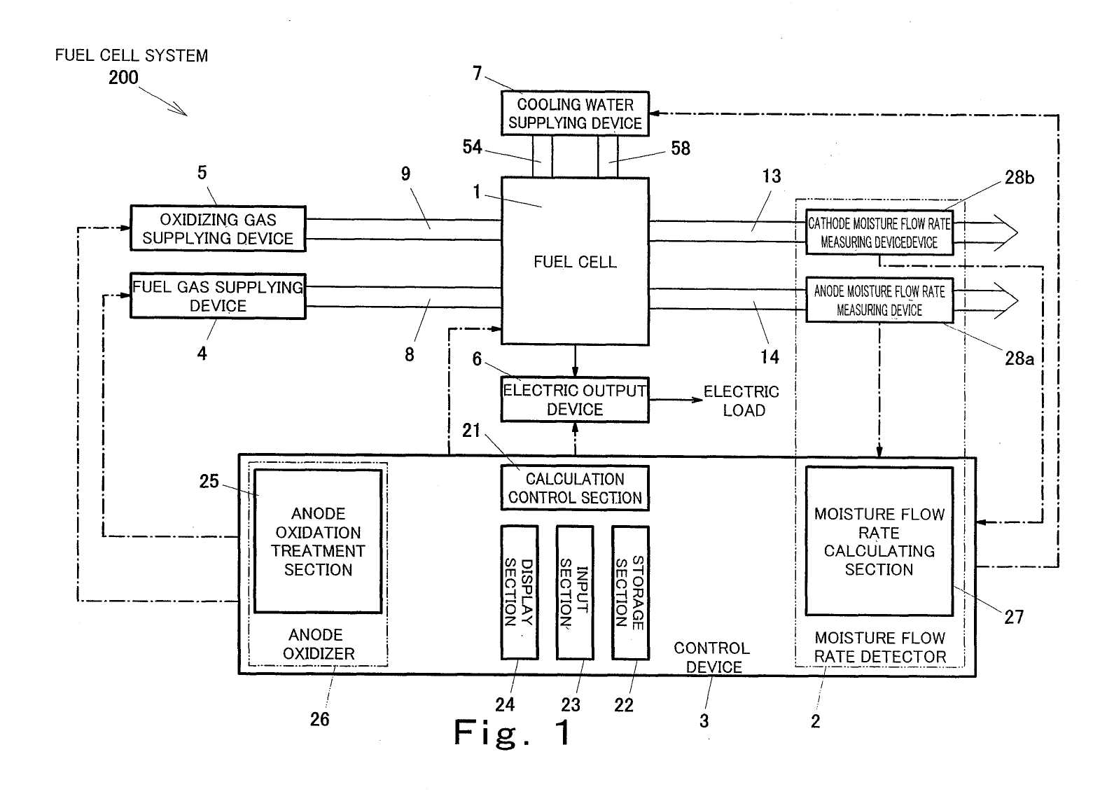

FIG. 1 is a block diagram schematically showing the configuration of the fuel cell system according to Embodiment 1 of the present invention.

First, the configuration of the fuel cell system according to Embodiment 1 will be explained.

As shown in FIG. 1, a fuel cell system 200 according to Embodiment 1 includes a polymer electrolyte fuel cell 1, a moisture flow rate detector 2, a control device 3, a fuel gas supplying device 4, a fuel gas supplying passage 8, an oxidizing gas supplying device 5, an oxidizing gas supplying passage 9, an electric output device 6, and a cooling water supplying device 7.

The fuel gas supplying passage 8 is connected to the polymer electrolyte fuel cell 1 (hereinafter simply referred to as “fuel cell 1”), and the fuel gas supplying device 4 is connected to the fuel gas supplying passage 8. The fuel gas supplying device 4 supplies a fuel gas to an anode of the fuel cell 1 through the fuel gas supplying passage 8. Herein, the fuel gas supplying device 4 includes: a plunger pump (not shown) which delivers to a fuel processor (not shown) a natural gas (material gas) supplied from a natural gas supplying infrastructure; a flow rate adjuster (not shown) capable of adjusting the amount of the natural gas delivered; and the fuel processor which reforms the delivered natural gas into a hydrogen-rich fuel gas. The fuel processor carries out a reforming reaction between the natural gas and steam to generate a reformed gas. Then, the fuel processor decreases carbon monoxide contained in this reformed gas up to about 1 ppm to generate the fuel gas. At this time, although the fuel gas contains a certain amount of steam having been subjected to the reforming reaction, the fuel gas may be further humidified using a certain amount of steam. The amount of steam contained in the fuel gas is controlled by the control device 3 even in the case of not humidifying the fuel gas or even in the case of humidifying the fuel gas. A steel pipe for gas piping is used as the fuel gas supplying passage 8.

Moreover, the oxidizing gas supplying passage 9 is connected to the fuel cell 1, and the oxidizing gas supplying device 5 is connected to the oxidizing gas supplying passage 9. The oxidizing gas supplying device 5 supplies an oxidizing gas to a cathode of the fuel cell 1 through the oxidizing gas supplying passage 9. Herein, the oxidizing gas supplying device 5 includes: a blower (not shown) whose inlet port opens in the atmosphere; a flow rate adjuster (not shown) capable of adjusting the flow rate of air; and a humidifier (not shown) which humidifies the air to be suctioned or the air suctioned, using a certain amount of steam. The amount of steam contained in the oxidizing gas supplied to the fuel cell 1 is controlled by the control device 3. The oxidizing gas supplying device 5 may be configured to use a fan or the like, such as a sirocco fan. Moreover, a steel pipe for gas piping is used as the oxidizing gas supplying passage 9.

The fuel cell 1 causes the supplied fuel gas containing hydrogen and the supplied oxidizing gas containing oxygen to electrochemically react to generate water and electricity. The generated water is discharged from the fuel cell 1 together with the unreacted reactant gas, and the flow rate of the water is detected by the moisture flow rate detector 2. A hydrogen gas and an alcohol fuel gas, such as methanol, may be used as the fuel gas.

The moisture flow rate detector 2 detects the flow rate (hereinafter referred to as “anode moisture flow rate”) of moisture discharged from the anode or the flow rate (hereinafter referred to as “cathode moisture flow rate”) of moisture discharged from the cathode. Steam contained in the oxidizing gas at this time is supplied to the humidifier to be reused. Moreover, the steam contained in the fuel gas is supplied to the fuel processor to be reused, and the fuel gas is supplied to a burner disposed in the fuel processor to be reused as a combustion fuel of the burner.

In the fuel cell 1, a cooling water supplying manifold (not shown) and a cooling water discharging manifold (not shown) are provided, a cooling water supplying passage 54 and a cooling water discharging passage 58 are connected to the cooling water supplying manifold and the cooling water discharging manifold, respectively, and the cooling water supplying passage 54 and the cooling water discharging passage 58 are connected to the cooling water supplying device 7. The cooling water supplying device 7 is configured to supply cooling water to the fuel cell 1 and cool down the discharged cooling water to maintain the cell at an appropriate temperature.

The electric output device 6 is connected to an electric terminal (not shown) of the fuel cell 1. The electric output device 6 is configured to include, for example, an inverter and a transformer to adjust the quantity of electricity, input from an electric load connected thereto, to have a voltage, a current or the like which is required by an output side.

The control device 3 is constructed of a computer, such as a microcomputer, and is configured to include: a computing unit (not shown), such as a CPU; a storage section 22, such as a memory; an input section 23, such as a keyboard; and a display section 24, such as a monitor. The control device 3 further includes the calculation control section 21, the anode oxidation treatment section 25 and the moisture flow rate calculating section 27. In the present embodiment, the anode oxidation treatment section 25 constitutes an anode oxidizer 26. The calculation control section 21, the anode oxidation treatment section 25 and the moisture flow rate calculating section 27 are realized by running a predetermined program, stored in the storage section 22, by the computing unit. These components of the control device 3 control, for example, the amount of the reactant gases, supplied from the fuel gas supplying device 4 and the oxidizing gas supplying device 5 to the fuel cell 1, to operate and control the fuel cell system 200. Specifically, the calculation control section 21 controls necessary components (not shown) of the fuel cell system 200 based on an input from, for example, a necessary sensor (not shown) to control the operation of the entire fuel cell system 200. Moreover, the anode oxidizer 26 (anode oxidation treatment section 25) detects the poisoning of the anode based on the anode moisture flow rate and cathode moisture flow rate, detected by the moisture flow rate detector 2, to control the fuel gas supplying device 4, the oxidizing gas supplying device 6 and the electric output device 6, thereby adjusting the potential of the anode. The determination as to whether the anode 16a is poisoned or not and the operation of adjusting the potential of the anode 16a will be described later. In the present embodiment, the storage section 22 constructed of an internal memory constitutes storage means. However, the storage means is not limited to this, and may be, for example, an external storage device constructed of a storage medium (hard disk, flexible disk or the like) and its driving device (hard disk drive, flexible disk drive or the like), or a storage server connected through a communication network.

In the present description, the control device denotes not only a single control device but also a group of a plurality of control devices which cooperate to control the fuel cell system 200. Therefore, the control device does not have to be constructed of a single control device, and may be constructed of a plurality of control devices which are dispersively disposed and cooperate to control the fuel cell system 200.

Next, the fuel cell 1 constituting the fuel cell system 200 according to Embodiment 1 will be explained.

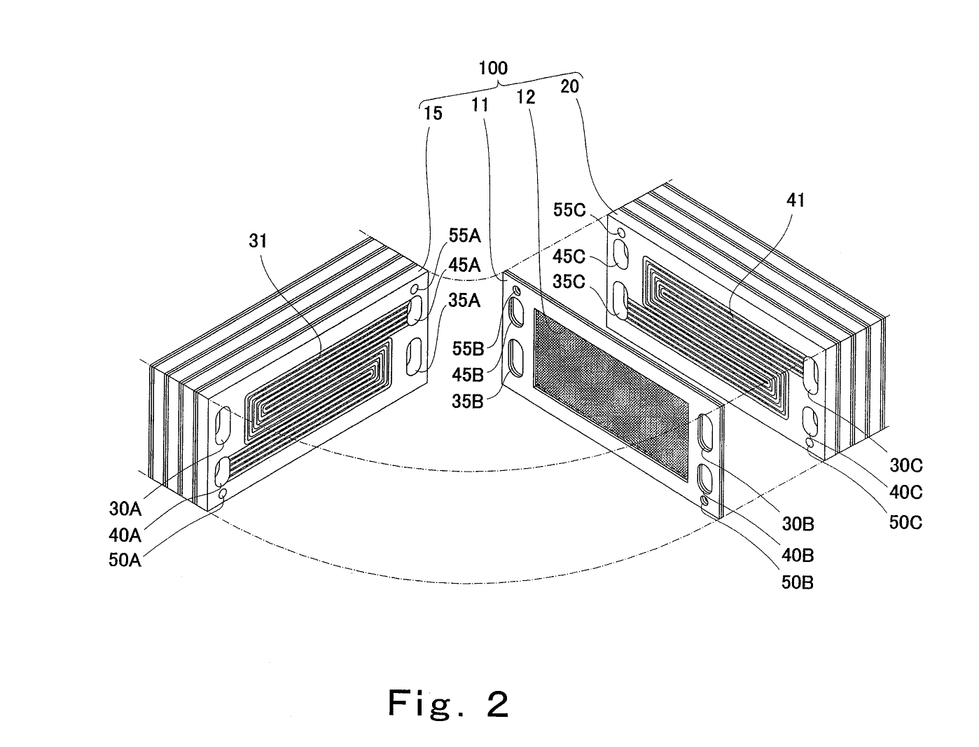

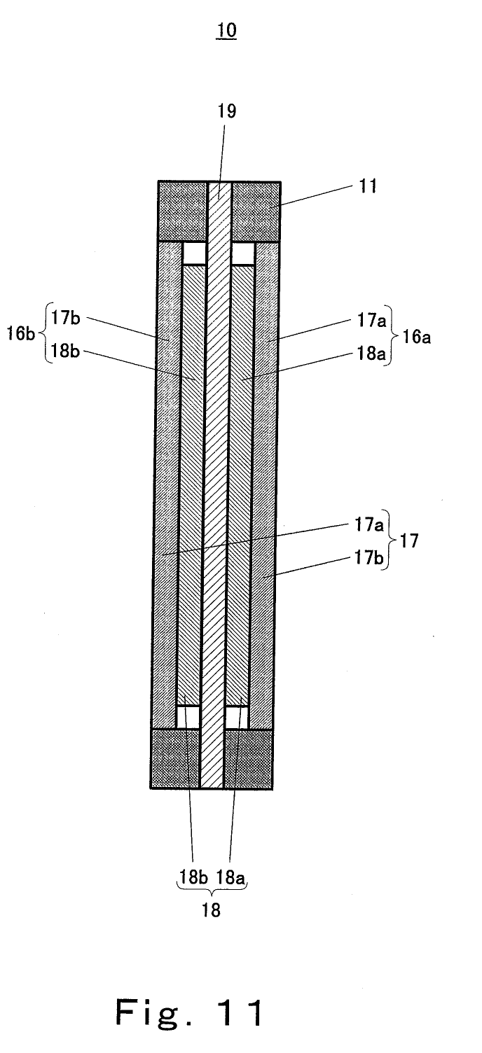

FIG. 2 is a developed view schematically showing a cell stack body constituting the fuel cell 1 and a cell constituting the cell stack body. FIG. 11 is a cross-sectional view schematically showing the configuration of the MEA of the cell shown in FIG. 2.

As shown in FIG. 2, the cell 100 includes an MEA (polymer electrolyte membrane-electrode assembly) 12, a gasket 11, an anode separator 20 and a cathode separator 15.

First, the MEA 12 will be explained.

As shown in FIG. 11, the MEA 12 includes: a polymer electrolyte membrane 19 which selectively transports a hydrogen ion; an anode 16a; and a cathode 16b (each of the anode 16a and the cathode 16b is called “gas diffusion electrode 16”). The anode 16a is disposed on one surface of the polymer electrolyte membrane 19 so as to be located inwardly of the peripheral portion of the polymer electrolyte membrane 19, and the cathode 16b is disposed on the other surface of the polymer electrolyte membrane 19 so as to be located inwardly of the peripheral portion of the polymer electrolyte membrane 19. The gas diffusion electrode 16 is disposed on a main surface of the polymer electrolyte membrane 19, and includes: a catalyst reaction layer 18 (anode catalyst layer 18a and cathode catalyst layer 18b) whose major component is carbon powder supporting a platinum-based metal catalyst; and a gas diffusion layer 17 (anode gas diffusion layer 17a and cathode gas diffusion layer 17b) which is disposed on the catalyst reaction layer 18 and has gas permeability and electric conductivity.

In the anode 16a, a reaction shown by Chemical Formula 1 occurs, and in the cathode 16b, a reaction shown by Chemical Formula 2 occurs.

H₂→2H⁺+2e⁻ Chemical Formula 1

½O₂+2H⁺+2e⁻→H₂O Chemical Formula 2

During the electric power generation of the fuel cell 1, a part of water generated in the cathode 16b back-diffuses and moves to the anode 16a.

Next, respective components of the MEA 12 will be explained.

One preferable example of the polymer electrolyte membrane 19 is a membrane which selectively allows the hydrogen ion to pass therethrough, that is, which has an ion exchange function. One preferable example of such membrane is a polymer electrolyte membrane having such a structure that —CF₂— is a main chain skeleton thereof and a sulfonic acid group is introduced to an end of a side chain thereof. One preferable example of the membrane having such structure is a perfluoro carbon sulfonic acid membrane (for example, Nafion 112 (trademark) produced by DuPont).

For example, a carbon paper (for example, TGP-H-090 (Product Name) produced by TORAY, Thickness: 270 μm) is used as the gas diffusion layer 17. In the case of adopting the carbon paper as the gas diffusion layer 17, the carbon paper having been subjected to water repellent finish is used. The water repellent finish is carried out by, for example, immersing the carbon paper in polytetrafluoroethylene (PTFE) aqueous dispersion, and then drying the carbon paper. Instead of the carbon paper, carbon cloth, or carbon felt made of carbon fiber, carbon powder, organic binder or the like may be used as the gas diffusion layer 17.

For example, used as electrode catalyst powder for the cathode 16b is catalyst powder obtained by causing ketjen black EC (Product Name, produced by AKZO Chemie) to support, for example, 25 weight percent platinum particles having a mean diameter of about 3 nm.

For example, used as electrode catalyst powder for the anode 16a is catalyst powder obtained by causing ketjen black EC (Product Name, produced by AKZO Chemie) to support, for example, 25 weight percent platinum-ruthenium alloy particles (for example, Pt:Ru=1:1 in mass ratio) having a mean diameter of about 3 nm.

As long as the gas diffusion electrode 16 can fulfill functions as a gas diffusion electrode, according to need, the gas diffusion electrode 16 may have such a stack body structure that the gas diffusion layer 17 for efficiently supplying the reactant gas to the catalyst reaction layer 18 is further disposed on an outer side of the catalyst reaction layer 18, and further, the gas diffusion electrode 16 may have such a stack body structure that an additional layer is formed at least one of a position between the gas diffusion layer 17 and the catalyst reaction layer 18 and a position between the catalyst reaction layer 18 and the polymer electrolyte membrane 19.

Next, the other components of the cell 100 will be explained.

As shown in FIGS. 2 and 11, a pair of gaskets 11 are disposed around the gas diffusion electrodes 16 so as to sandwich the polymer electrolyte membrane 19. With this, the fuel gas and the oxidizing gas are prevented from leaking outside the cell, and these gases are prevented from being mixed with each other.

The MEA 12 and the gasket 11 have through holes extending in a thickness direction, that is, an oxidizing gas supplying manifold hole 30B, a fuel gas supplying manifold hole 40B, a cooling water supplying manifold hole 50B, an oxidizing gas discharging manifold hole 35B, a fuel gas discharging manifold hole 45B and a cooling water discharging manifold hole 55B. An assembly obtained by integrating the MEA 12 and the gasket 11 is called an MEA-gasket assembly 10 (see FIG. 11).

Then, the electrically-conductive anode separator 20 and the electrically-conductive cathode separator 15 are disposed to sandwich the MEA 12 and the gasket 11. Used as each separator is a resin-impregnated carbon plate obtained by impregnating a carbon plate, obtained by cold pressing a carbon powder material, with phenol resin and then hardening the carbon plate. Alternatively, a separator made of a metallic material, such as SUS, may be used as each separator. The MEA 9 is mechanically fixed by the anode separator 15 and the cathode separator 20, and adjacent MEAs are electrically connected to one another in series.

The anode separator 20 has on its peripheral portion through holes extending in a thickness direction, that is, an oxidizing gas supplying manifold hole 30C, a fuel gas supplying manifold hole 40C, a cooling water supplying manifold hole 50C, an oxidizing gas discharging manifold hole 35C, a fuel gas discharging manifold hole 45C and a cooling water discharging manifold hole 55C. A gas passage 41 through which the fuel gas flows is provided on an inner surface (surface contacting the MEA 12) of the anode separator 20. The gas passage 41 is formed in the shape of a groove and is provided on the anode separator 20 in a serpentine shape so as to connect the fuel gas supplying manifold hole 40C and the fuel gas discharging manifold hole 45C.

The cathode separator 15 has on its peripheral portion through holes extending in a thickness direction, that is, an oxidizing gas supplying manifold hole 30A, a fuel gas supplying manifold hole 40A, a cooling water supplying manifold hole 50A, an oxidizing gas discharging manifold hole 35A, a fuel gas discharging manifold hole 45A and a cooling water discharging manifold hole 55A. A gas passage 31 through which the oxidizing gas flows is provided on an inner surface (surface contacting the MEA 12) of the cathode separator 15. The gas passage 31 is formed in the shape of a groove and is provided on the cathode separator 15 in a serpentine shape so as to connect the oxidizing gas supplying manifold hole 30A and the oxidizing gas discharging manifold hole 35A.

Moreover, a cooling water passage (not shown) through which the cooling water flows is provided on an outer surface of each of the anode separator 20 and the cathode separator 15. The cooling water passage is formed in the shape of a groove to connect the cooling water supplying manifold hole 50A and the cooling water discharging manifold hole 55A or connect the cooling water supplying manifold hole 50C and the cooling water discharging manifold hole 55C. With this, it is possible to maintain the cell 100 at a predetermined temperature suitable for the electrochemical reaction.

A cell stack body is formed by stacking the above cells 100 in a thickness direction. The fuel gas supplying manifold holes 40A, 40B and 40C provided on the MEA 12, the gasket 11, the anode separator 20 and the cathode separator 15 are connected to one another in a thickness direction by stacking the cells 100 to form the fuel gas supplying manifold, and the fuel gas discharging manifold holes 45A, 45B and 45C provided on the MEA 12, the gasket 11, the anode separator 20 and the cathode separator 15 are connected to one another in a thickness direction by stacking the cells 100 to form the fuel gas discharging manifold. Similarly, the oxidizing gas supplying manifold holes 30A, 30B and 40C are connected to one another in a thickness direction to form the oxidizing gas supplying manifold, and the oxidizing gas discharging manifold holes 35A, 35B and 35C are connected to one another in a thickness direction to form the oxidizing gas discharging manifold. Moreover, the cooling water supplying manifold holes 50A, 50B and 50C are connected to one another in a thickness direction to form the cooling water supplying manifold, and the cooling water discharging manifold holes 55A, 55B and 55C are connected to one another in a thickness direction to form the cooling water discharging manifold.

The fuel gas supplying manifold is connected to the fuel gas supplying passage 8, and the oxidizing gas supplying manifold is connected to the oxidizing gas supplying passage 9. Moreover, the fuel gas discharging manifold is connected to a fuel gas discharging passage 14 constructed of a suitable pipe, and the oxidizing gas discharging manifold is connected to an oxidizing gas discharging passage 13 constructed of a suitable pipe. The moisture flow rate detector 2 is disposed at a portion of each of the fuel gas discharging passage 14 and the oxidizing gas discharging passage 13.

With this, the oxidizing gas having been supplied from the oxidizing gas supplying device 5 through the oxidizing gas supplying passage 9 is supplied from the oxidizing gas supplying manifold through the gas passage 31 to the cathode 16b, the water generated by the electrochemical reaction and the unused oxidizing gas are discharged from the oxidizing gas discharging manifold through the oxidizing gas discharging passage 13, and the water and the unused oxidizing gas pass through the moisture flow rate detector 2 during this discharging. Moreover, the fuel gas having been supplied from the fuel gas supplying device 4 through the fuel gas supplying passage 8 is supplied from the fuel gas supplying manifold through the gas passage 41 to the anode 16a, the water having back-diffused from the cathode 16b to the anode 16a and the unused fuel gas are discharged from the fuel gas discharging manifold through the fuel gas discharging passage 14, and the water and the unused fuel gas pass through the moisture flow rate detector 2 during this discharging.

Design conditions, such as the shapes of the manifolds, the positions where the manifolds are formed, the shapes of the passages and the positions where the passages are formed, shown in FIG. 2 are merely exemplary, and the configuration of the fuel cell mounted on the fuel cell system of the present invention is not limited to this. Each manifold can be arbitrarily formed on the peripheral portion of each separator, and it is possible to accordingly change design conditions, such as the shapes of a supply side and discharge side of the reactant gas, the shapes of a supply side and discharge side of the cooling water, the positions where the supply side and discharge side of the reactant gas are formed, the positions where the supply side and discharge side of the cooling water are formed, the shapes of the passages, and the positions where the passages are formed. Moreover, in the present embodiment, the cell stack body is formed by stacking the cells. However, the present embodiment is not limited to this, and the fuel cell 1 may be constructed of a unit cell.

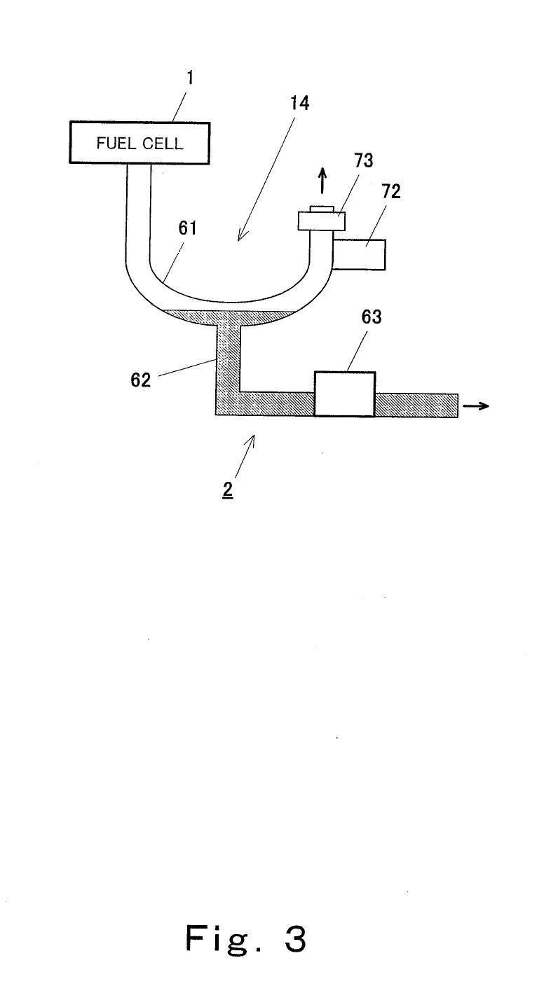

Next, the moisture flow rate detector 2 of the fuel cell system 200 according to Embodiment 1 will be explained in detail in reference to FIGS. 1 and 3.

FIG. 3 is a schematic diagram showing the configuration of the moisture flow rate detector 2 of the fuel cell system 200 according to Embodiment 1.

As shown in FIG. 1, the moisture flow rate detector 2 includes an anode moisture flow rate measuring device 28a, a cathode moisture flow rate measuring device 28b and the moisture flow rate calculating section 27, and detects the flow rate of moisture discharged from the fuel cell 1. Examples of the moisture discharged from the fuel cell 1 are steam that is a gas generated by the humidified reactant gas flowing in the gas diffusion electrode 16, water that is a liquid generated by the electrochemical reaction in the cathode 16b, and water that is a liquid which back-diffuses from the cathode 16b to the anode 16a.

First, an anode moisture flow rate detector will be explained.

The anode moisture flow rate detector is constructed of the anode moisture flow rate measuring device 28a and the moisture flow rate calculating section 27. As shown in FIG. 3, the anode moisture flow rate measuring device 28a is constructed of a dew point meter 72, a flowmeter 73 and a water flow rate detector. The water flow rate detector includes, for example, a U pipe 61 having a U shape. One end portion of the U pipe 61 is connected to a portion of the fuel gas discharging passage 14 on the fuel cell 1 side, and the other end portion is connected to a portion of the fuel gas discharging passage 14 on a discharge side via a condensed water tank (not shown). A detector pipe 62 is disposed at a curved portion, which is a lower portion of the U pipe 61, so as to extend downwardly and communicate with the U pipe 61. A predetermined flow rate detecting device 63 is connected to the detector pipe 62. Examples of the flow rate detecting device 63 are a ventulimeter and an orifice meter. The detector pipe 62 is connected to the condensed water tank.

Herein, the dew point meter 72 and the flowmeter 73 are disposed downstream of the U pipe 61 to measure the dew point and flow rate of the fuel gas which passes through the U pipe 61 and contains steam. The measured dew point and flow rate are transmitted to the moisture flow rate calculating section 27. The dew point meter 72 and the flowmeter 73 just have to measure the dew point and flow rate of the fuel gas which has been discharged from the anode 16a of the fuel cell 1 and contains steam, and for example, they may be disposed on a portion of the fuel gas discharging passage 14.

With this, the unused fuel gas which has been discharged from the anode 16a and contains steam passes through the U pipe 61 to be delivered to the condensed water tank. Meanwhile, the water having been discharged from the anode 16a flows from the curved portion of the U pipe 61 into the detector pipe 62 to flow out to the condensed water tank. In this process, the flow rate of the water flowing in the detector pipe 62 is detected by the flow rate detecting device 63. The detected flow rate of the water is transmitted to the moisture flow rate calculating section 27 of the control device 3. The moisture flow rate calculating section 27 of the control device 3 calculates the flow rate of the steam from the dew point and flow rate of the fuel gas containing the steam, which have been measured by the dew point meter 72 and the flowmeter 73. Then, the moisture flow rate calculating section 27 of the control device 3 calculates (detects) the anode moisture flow rate from the calculated flow rate of the steam and the flow rate of water detected by the flow rate detecting device 63. After that, the calculated anode moisture flow rate is transmitted to the anode oxidation treatment section 25. The steam having been delivered to the condensed water tank is condensed to be separated from the unused fuel gas, and the fuel gas is used as the combustion fuel of the burner of the fuel processor (not shown). Moreover, the impurity is removed from the water in the condensed water tank using a filter such that the water becomes pure water. The pure water is supplied to the cooling water supplying device 7, the humidifier or the fuel processor.

Although the foregoing has explained the anode moisture flow rate detector in the moisture flow rate detector 2, the cathode moisture flow rate detector is configured in the same manner. The cathode moisture flow rate detector is different from the anode moisture flow rate detector in that the U pipe 61 is disposed on a portion of the oxidizing gas discharging passage 13.

The present embodiment is configured such that the flow rate detecting device 63 is connected to the detector pipe 62. Alternatively, the present embodiment may be configured such that a measuring container is disposed on the detector pipe 62 to detect the weight of water stored in the measuring container for a certain period of time. In a case where the output of the fuel cell 1 is constant, the flow rate of the steam is uniquely determined based on the flow rate and dew point of the reactant gas. Therefore, the present embodiment may be configured such that without calculating the flow rate of the steam, the flow rate of water having been detected by the flow rate detecting device 62 is regarded as the anode moisture flow rate or the cathode moisture flow rate.

The fuel cell 1 is a common polymer electrolyte fuel cell, and may be a fixed type for a private electric power generator or a mobile type for a power source of an automobile. In the present embodiment, a fixed type polymer electrolyte fuel cell is used.

Next, a method for operating the fuel cell system 200 according to Embodiment 1 configured as above will be explained in detail.

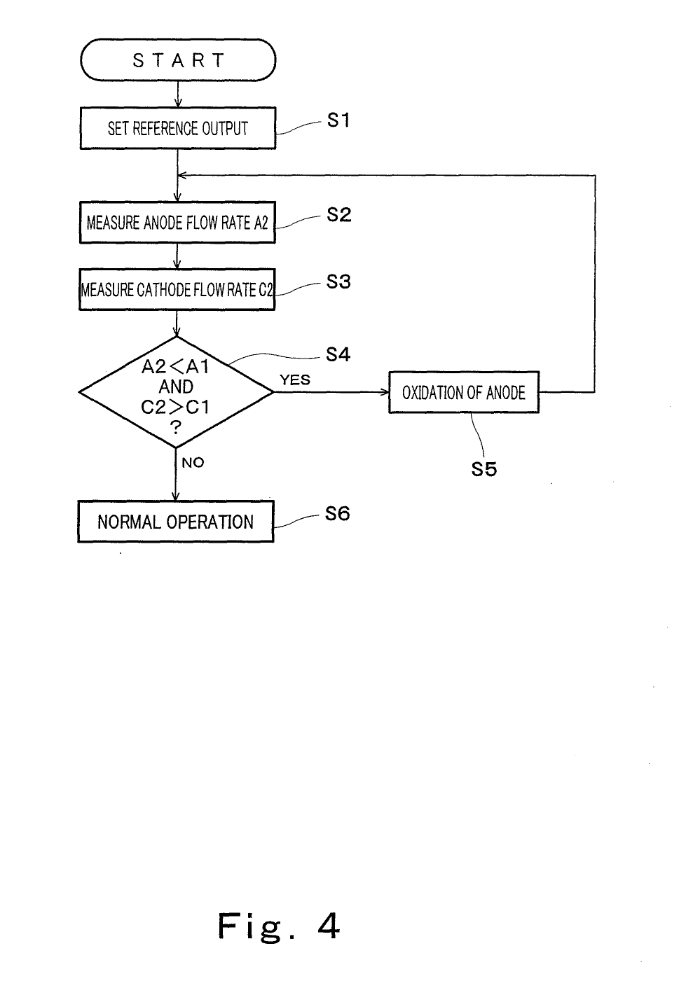

FIG. 4 is a flow chart schematically showing a content of an anode potential adjustment program stored in the control device 3.

First, the anode oxidation treatment section 25 of the control device 3 controls the electric output device 6, the fuel gas supplying device 4 and the oxidizing gas supplying device 5 to cause the fuel cell 1 to generate electric power under condition of a certain electric power output (output current density) and a certain supply flow rate and dew point of the reactant gas (this condition is hereinafter referred to as “reference output”). The reference output is input from the input section 23, and an input value of the reference output is displayed on the display section 24 by the computing unit and stored in the storage section 22. The storage section 22 stores an anode reference moisture flow rate (A1) and cathode reference moisture flow rate (C1) corresponding to the prestored reference output. Moreover, as a method for setting the anode reference moisture flow rate (A1) and the cathode reference moisture flow rate (C1), the flow rates of water discharged from the anode 16a and the cathode 16b of the fuel cell 1 operated under condition of the reference output may be detected by the moisture flow rate detector 2, the anode reference moisture flow rate (A1) and the cathode reference moisture flow rate (C1) may be calculated from the detected flow rates of water and the calculated flow rate of steam, and these values may be stored in the storage section 22. Thus, the reference output is set (Step S1).

Next, in the reference output state, the anode oxidation treatment section 25 detects the anode moisture flow rate (A2) (Step S2) and the cathode moisture flow rate (C2) (Step S3) via the moisture flow rate detector 2 during the operation of the fuel cell 1. Then, the anode moisture flow rate (A2) is compared with the anode reference moisture flow rate (A1) stored in the storage section 22, and the cathode moisture flow rate (C2) is compared with the cathode reference moisture flow rate (C1) stored in the storage section 22 (Step S4). In a case where the anode moisture flow rate (A2) is lower than the anode reference moisture flow rate (A1), and the cathode moisture flow rate (C2) is higher than the cathode reference moisture flow rate (C1), it is determined that the anode 16a is poisoned. In contrast, in a case where the anode moisture flow rate (A2) is higher than the anode reference moisture flow rate (A1), and the cathode moisture flow rate (C2) is lower than the cathode reference moisture flow rate (C1), the fuel cell 1 carries out a normal operation (Step S6). When the anode moisture flow rate (A2) is lower than the anode reference moisture flow rate (A1), the cathode moisture flow rate (C2) is surely higher than the cathode reference moisture flow rate (C1).

Next, when the anode 16a is poisoned, the anode oxidation treatment section 25 controls the fuel gas supplying device 4, the oxidizing gas supplying device 5 and the electric output device 6 to increase the potential of the anode 16a in a range from 0 to +1.23V with respect to a standard hydrogen electrode, thereby oxidizing and removing the impurity adhered to the anode 16a (Step S5).

Next, the adjustment of the potential of the anode 16a will be explained in detail in reference to FIG. 1.

The anode oxidation treatment section 25 of the control device 3 controls to maintain a predetermined flow rate of the oxidizing gas supplied from the oxidizing gas supplying device 5 to the fuel cell 1 and a predetermined electric power output of the electric output device 6 at the time of the reference output. Then, the anode oxidation treatment section 25 controls the fuel gas supplying device 4 to decrease the flow rate of the fuel gas supplied to the fuel cell 1. With this, since the fuel gas is insufficient with respect to a necessary electric power output, the potential of the anode 16a increases, thereby oxidizing and removing the impurity adhered to the anode 16a.

Then, when the anode oxidation treatment section 25 realizes the reference output state again, and the moisture flow rate detector 2 detects that the anode moisture flow rate (A2) and the cathode moisture flow rate (C2) are equal to the anode reference moisture flow rate (A1) and cathode reference moisture flow rate (C1), respectively, under condition of the detected reference output, the anode oxidation treatment section 25 determines that the oxidation and removal of the impurity are terminated, and carries out the normal operation (Step S6).

Since the theoretical electromotive force is +1.23V with respect to the standard hydrogen electrode in the fuel cell which causes hydrogen and oxygen to react, it is possible to increase the potential of the anode 16a up to +1.23V. The fuel cell system 200 according to Embodiment 1 suitably adjusts the potential of the anode 16a in a range from 0 to +1.23V with respect to the standard hydrogen electrode, thereby oxidizing and removing the impurity adhered to the anode 16a. It is preferable that a potential at which the impurity (poisoning component adsorbed to the anode) to be adhered to the anode is electrochemically oxidized be obtained in advance from an experiment or the like, and the potential of the anode be adjusted to be the obtained potential or more, thereby oxidizing and removing the impurity adhered to the anode 16a. For example, as will be explained in Example 2 below, the potential of the anode 16a may be adjusted in a range from +0.8 to 1.23V, thereby oxidizing and removing the impurity adhered to the anode 16a.

With this configuration, it is possible to detect the decrease in performance of the fuel cell due to the impurity adhered only to the anode (due to the poisoning of the anode). Therefore, it becomes possible to restore the performance of the polymer electrolyte fuel cell while minimizing the deterioration of the anode due to the oxidation treatment.

Next, a modification example of the moisture flow rate detector 2 in the fuel cell system 200 according to Embodiment 1 will be explained.

### Modification Example 1

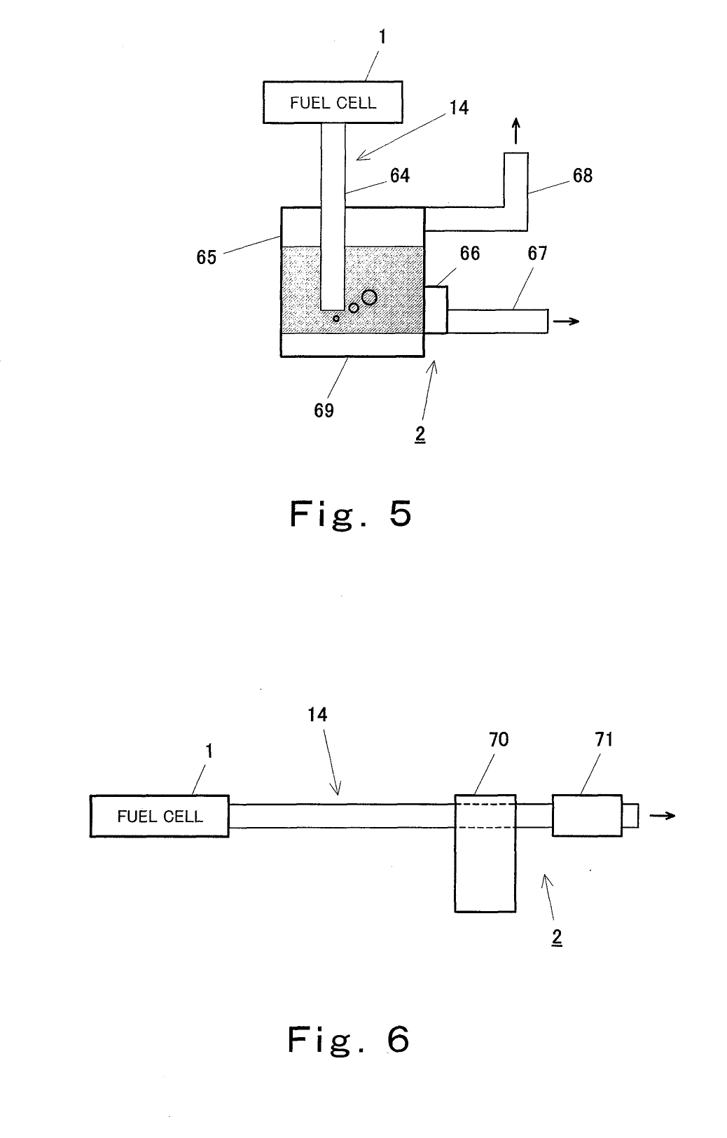

FIG. 5 is a schematic diagram showing Modification Example 1 of the moisture flow rate detector 2 in the fuel cell system 200 according to Embodiment 1.

As shown in FIG. 5, the anode moisture flow rate detector of the moisture flow rate detector 2 in the present modification example is configured to condense the steam, discharged from the anode 16a, into water by bubbling without using the U pipe to detect the flow rate (weight) of moisture per a certain period of time. Specifically, the fuel gas discharging passage 14 includes a measuring container pipe 64. The measuring container pipe 64 is disposed to extend downwardly from the fuel gas discharging manifold (not shown) of the fuel cell 1, penetrate through an upper portion of a measuring container 65, and reach the vicinity of a bottom portion of the measuring container 65. The measuring container 65 stores a predetermined weight of water such that an end portion of the measuring container pipe 64 is immersed in the water at all times. A condensed water tank pipe 68 is connected to an upper end portion of the measuring container 65. The condensed water tank pipe 68 is connected to the condensed water tank (not shown). A discharge outlet is formed at a lower end portion of the measuring container 65, and a discharge valve 66 is disposed on the discharge outlet. The discharge outlet and a discharge pipe 67 communicate with each other through the discharge valve 66. The discharge pipe 67 is connected to the condensed water tank. Moreover, a weighing machine 69 constructed of a weight sensor, such as a load cell, is disposed at a lower end of the measuring container 65 to detect the increased weight of water in a certain period of time. The measuring container pipe 64, the discharge pipe 67 and the condensed water tank pipe 68 are flexibly connected to the measuring container 65, and the weighing machine 69 can measure the weight of the measuring container 65 (to be precise, the increased weight of water per a certain period of time).

With this, the moisture discharged from the anode 16a and the unused fuel gas pass through the measuring container pipe 64 to be introduced to the measuring container 65. The moisture is stored in the measuring container 65 for a certain period of time. At this time, the steam is cooled down by bubbling to be condensed into water which is stored. In contrast, the unused fuel gas after the bubbling flows out to the condensed water tank pipe 68. The stored water is detected by the weighing machine 69, the weight (flow rate) detected by the weighing machine 69 is transmitted to the moisture flow rate calculating section 27 of the control device 3, and the anode moisture flow rate is calculated (detected) by the moisture flow rate calculating section 27 of the control device 3. After detecting the weight, the moisture flow rate calculating section 27 of the control device 3 opens the discharge valve 65 to deliver the water in the measuring container 65 to the condensed water tank while leaving a certain amount of water. In order to accelerate the condensation of the steam, the measuring container 69 may be cooled down.

With this configuration, the steam that is a gas in the moisture discharged from the anode 16a is condensed into water, and the flow rate of this water and the water that is a liquid discharged from the anode 16a is detected. Therefore, it becomes possible to surely measure the anode moisture flow rate.

Since the unused fuel gas discharged from the condensed water tank pipe 67 contains steam, a dew point meter and a gas flow meter may be disposed on the condensed water tank pipe 67 to detect the flow rate of the steam, thereby correcting the flow rate by the moisture flow rate calculating section 27 of the control device 3. Although the foregoing has explained the anode moisture flow rate detector, the cathode moisture flow rate detector is configured in the same manner, so that explanations thereof are omitted.

### Modification Example 2

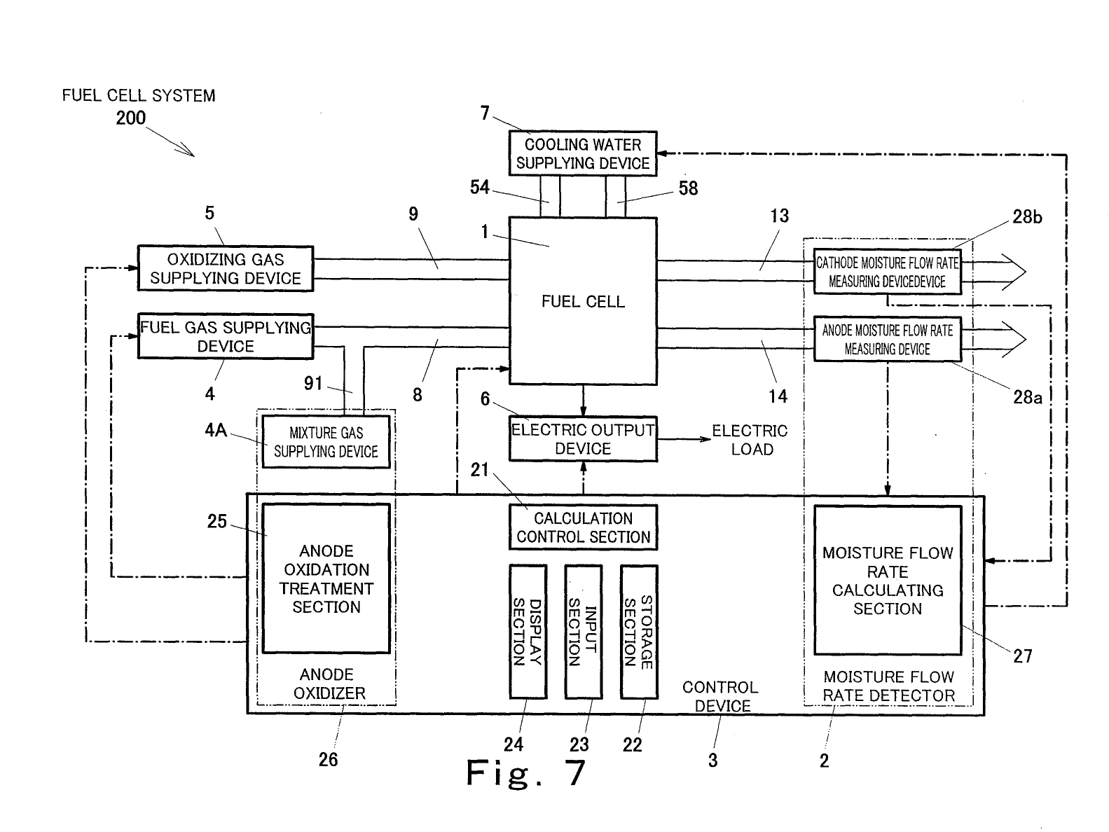

FIG. 6 is a schematic diagram showing Modification Example 2 of the moisture flow rate detector 2 in Embodiment 1.

As shown in FIG. 6, the moisture flow rate detector 2 (here, the anode moisture flow rate detector) is configured to heat a part of the fuel gas discharging passage 14. Specifically, a heat exchanger 70 is disposed on a portion of the fuel gas discharging passage 14. Then, the unused fuel gas which is discharged from the anode 16a and contains steam and the water flow on one side of the heat exchanger 70, and a combustion gas discharged from the burner of the fuel processor flows on the other side. The heat exchanger 70 carries out heat exchange so as to heat the steam, the unused fuel gas and the water by the combustion gas. A gas flow meter 71 is disposed downstream of the heat exchanger 70. Therefore, all the water discharged from the anode 16a is vaporized, and the flow rate and dew point of the gas containing the generated steam is detected by the gas flow meter 71. The detected flow rate and dew point are transmitted to the moisture flow rate calculating section 27 of the control device 3, and the moisture flow rate calculating section 27 of the control device 3 calculates (detects) the anode moisture flow rate. The gas having passed through the gas flow meter 71 and containing the steam flows into the condensed water tank (not shown).

Although the foregoing has explained the anode moisture flow rate detector, the cathode moisture flow rate detector is configured in the same manner, so that explanations thereof are omitted.

### Modification Example 3

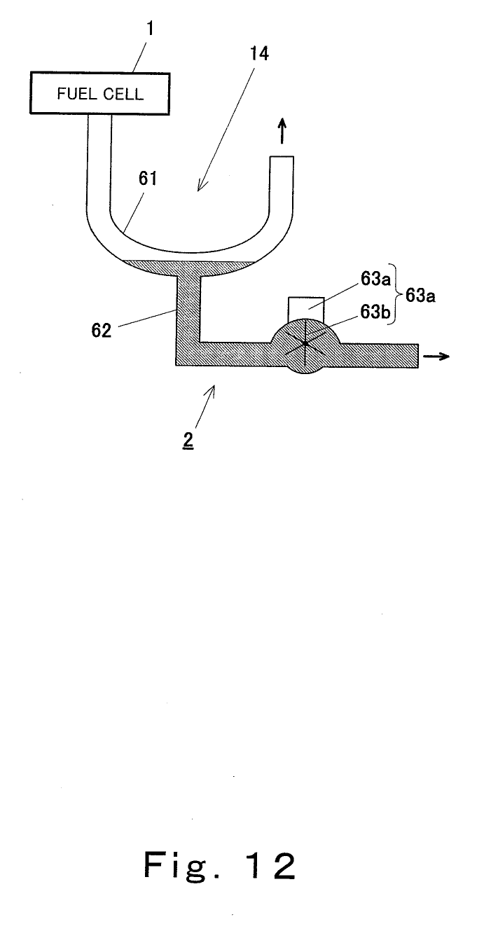

FIG. 12 is a schematic diagram showing Modification Example 3 of the moisture flow rate detector 2 in Embodiment 1.

In Modification Example 3, a known impeller flow meter is used as the flow rate detecting device 63 of the moisture flow rate detector 2. As shown in FIG. 12, an impeller flow meter 63 is constructed of an impeller section 63a and a detecting section 63b, and is disposed on an appropriate portion of the detector pipe 62.

The impeller section 63a includes an impeller and a bearing. Here, the impeller section 63a is disposed such that a main surface of each blade of the impeller is substantially perpendicular to the direction of the flow of the water (the bearing is substantially perpendicular to the direction of the flow of the water) and the main surface of each blade of the impeller deviates from a center line of the flow of the water. The detecting section 63b detects the rotation of the impeller and transmits the rotating speed as the flow rate of water to the moisture flow rate calculating section 27 of the control device 3. Examples of a method for detecting the rotation of the impeller are a method for mechanically transmitting the rotation of the impeller outside the detector pipe 62 to detect the rotation of the impeller and a method for detecting the rotation of the impeller by infrared. The other example is a method for forming the detector pipe 62 using a nonmagnetic material and the blade of the impeller using a magnetic material and constituting the detecting section 63b by a magnet and a detecting coil to detect by the detecting coil a flux change caused due to the rotation of the impeller.

Other than the impeller flow meter, a known flow meter, such as a turbine flow meter, an ultrasonic flow meter and an electromagnetic flow meter, may be used as the flow rate detecting device 63.

Next, a modification example of a method for oxidizing the anode 16a of the fuel cell 1 of the fuel cell system 200 according to Embodiment 1 will be explained.

### Modification Example 4

In Modification Example 4, the anode oxidation treatment section 25 (anode oxidizer 26) of the control device 3 controls the fuel gas supplying device 4 to maintain the fuel gas flow rate at the time of the reference output and controls the electric output device 6 to cause the output current density to be higher than the output current density at the time of the reference output. At this time, the anode oxidation treatment section 25 of the control device 3 controls the oxidizing gas supplying device 5 to supply the oxidizing gas corresponding to the output current density such that the potential of the cathode 16b does not decrease.

With this, since the fuel gas flow rate necessary to correspond to the increased output current density is insufficient in the anode 16a, the potential of the anode 16a can be increased to oxidize the anode 16a, thereby removing the impurity.

### Modification Example 5

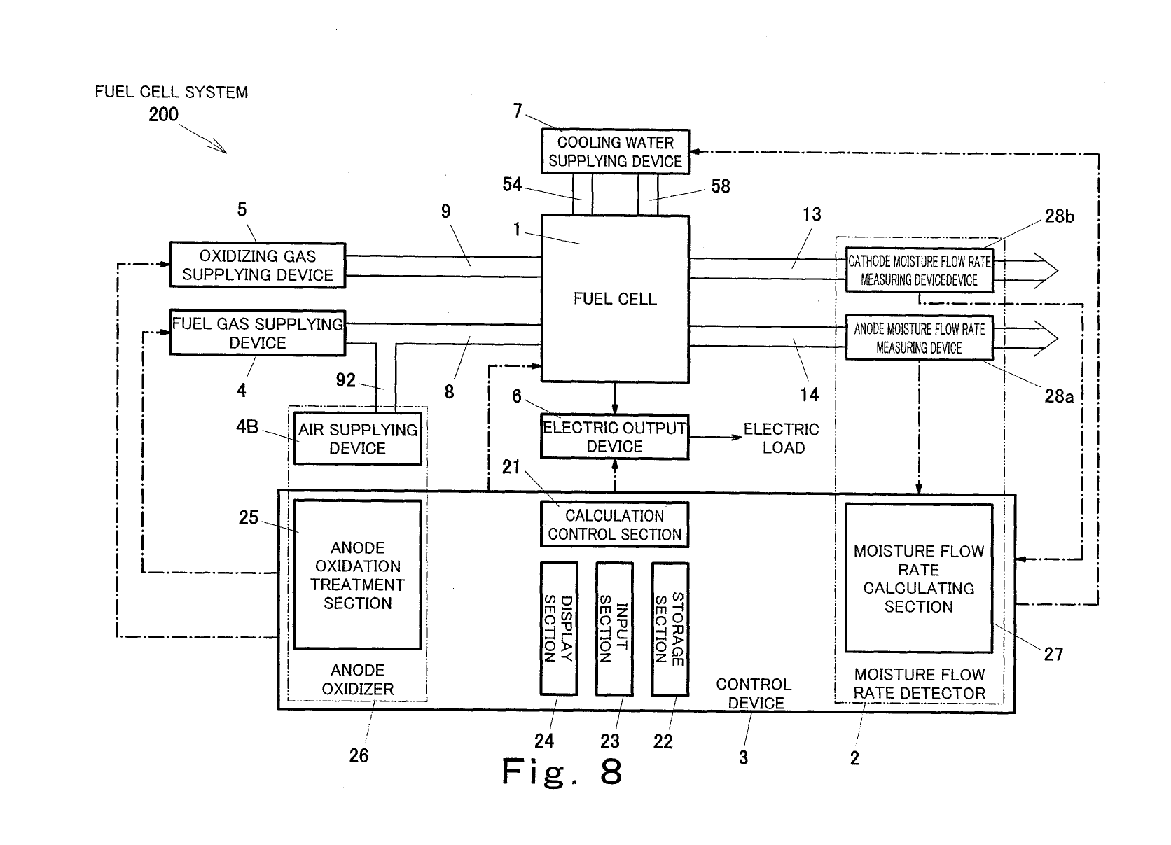

FIG. 7 is a block diagram schematically showing the configuration of Modification Example 5 in the fuel cell system 200 according to Embodiment 1.

As shown in FIG. 7, the anode oxidizer 26 in the fuel cell system 200 of Modification Example 5 is constructed of a mixture gas supplying device 4A and the anode oxidation treatment section 25. The mixture gas supplying device 4A includes a container (not shown) for storing a mixture gas and a flow rate adjuster (not shown) for adjusting the supply amount of the mixture gas. The container is connected to the fuel gas supplying passage 8 via a mixture gas passage 91, and the flow rate adjuster is controlled by the anode oxidation treatment section 25 of the control device 3. The anode oxidation treatment section 25 of the control device 3 controls the fuel gas supplying device 4, the oxidizing gas supplying device 5 and the electric output device 6 to maintain the fuel gas flow rate, the oxidizing gas flow rate and the electric power output at the time of the reference output. At this time, the anode oxidation treatment section 25 of the control device 3 controls to adjust the flow rate of mixture gas, which is supplied from the mixture gas supplying device 4A and mixed with the fuel gas, to decrease the concentration of the hydrogen gas in the gas supplied to the fuel cell 1.

With this, since the concentration of the hydrogen gas in the gas supplied to the anode 16a decreases, the potential of the anode 16a can be increased to remove the impurity.

In order to increase the potential of the anode 16a, ionization energy of the mixture gas needs to be smaller than that of hydrogen. Examples of such mixture gas are a material gas and an inactive gas.

In the case of using the material gas (natural gas) as the mixture gas, the material gas may be bypassed from the natural gas supplying infrastructure constituting the fuel gas supplying device 4 to the fuel gas supplying passage 8, and the flow rate of the supplied natural gas may be adjusted by the anode oxidation treatment section 25 of the control device 3.

### Modification Example 6

FIG. 8 is a block diagram schematically showing the configuration of Modification Example 6 in the fuel cell system 200 according to Embodiment 1.

As shown in FIG. 8, the anode oxidizer 26 of Modification Example 6 is configured such that the mixture gas supplying device 4A of Modification Example 5 is replaced with an air supplying device 4B, and air is used as the mixture gas. The air supplying device 4B includes a blower (not shown) which is open in the atmosphere and a flow rate adjuster (not shown) which adjusts a supply amount of air. The blower is connected to the fuel gas supplying passage 8 via an air supplying passage 92.

With this, by supplying the air from the air supplying device 4B to the anode 16a in a state where the fuel cell 1 is not generating the electric power and the material gas or the reformed gas is not supplied to the anode 16a, the anode 16a carries out the oxidation-reduction reaction with oxygen. Thus, the potential of the anode 16a can be increased to remove the impurity.

The air supplying device 4B may be constructed of the oxidizing gas supplying device 5, the oxidizing gas (air) may be supplied from the oxidizing gas supplying device to the fuel gas supplying passage 8 by suitable means, and the amount of the oxidizing gas supplied to the fuel gas supplying passage 8 may be controlled by the anode oxidation treatment section 25 of the control device 3.

The embodiment of the present invention has explained that both the anode moisture flow rate and the cathode moisture flow rate are measured to determine whether or not the anode is poisoned. However, the embodiment of the present invention is not limited to this, and may be configured such that one of the anode moisture flow rate and the cathode moisture flow rate is measured to determine whether or not the anode is poisoned.

From the foregoing explanation, many modifications and other embodiments of the present invention are obvious to one skilled in the art. Therefore, the foregoing explanation should be interpreted only as an example, and is provided for the purpose of teaching the best mode for carrying out the present invention to one skilled in the art. The structures and/or functional details may be substantially modified within the spirit of the present invention.

### EXAMPLES

Hereinafter, operational advantages of the present invention will be specifically explained using Example 1 and Comparative Example 1.

### Example 1

In the present example, a fuel cell system having the same configuration as the fuel cell system 200 according to Embodiment 1 of the present invention was configured. An operation explained below was carried out using this fuel cell system.

The cooling water was supplied from the cooling water supplying device 7 to the cooling water supplying manifold of the fuel cell 1 to maintain the internal temperature of the fuel cell 1 (to be precise, the temperature inside the MEA 12) at 65° C.

The fuel gas humidified and heated to have a dew point of 65° C. was supplied from the fuel gas supplying device 4 to the fuel gas supplying manifold. The supply of the fuel gas was controlled such that the utilization ratio of the fuel gas became 80%.

The oxidizing gas humidified and heated to have a dew point of 65° C. was supplied from the oxidizing gas supplying device 5 to the oxidizing gas supplying manifold. The supply of the oxidizing gas was controlled such that the utilization ratio of the oxidizing gas became 45%.

The fuel cell 1 was operated by such a certain electric load that the electric power output of the fuel cell 1 had an average cell voltage of 0.7V or more and a current density of 0.3 A/cm².

In the reference output in which the electric load and the flow rates and dew points of the supplied fuel gas and oxidizing gas are constant, all the moisture discharged from the anode 16a was collected by the anode moisture flow rate detector as water having a temperature of 25° C., and the flow rate of the water was detected and regarded as the anode reference moisture flow rate. Similarly, all the moisture discharged from the cathode 16b was collected by the cathode moisture flow rate detector as water having a temperature of 25° C., and the flow rate of the water was detected and regarded as the cathode reference moisture flow rate. In the present example below, in accordance with the same method as above, the moisture discharged from the fuel cell 1 was collected, and the anode moisture flow rate and the cathode moisture flow rate that were the flow rates of the water were detected.

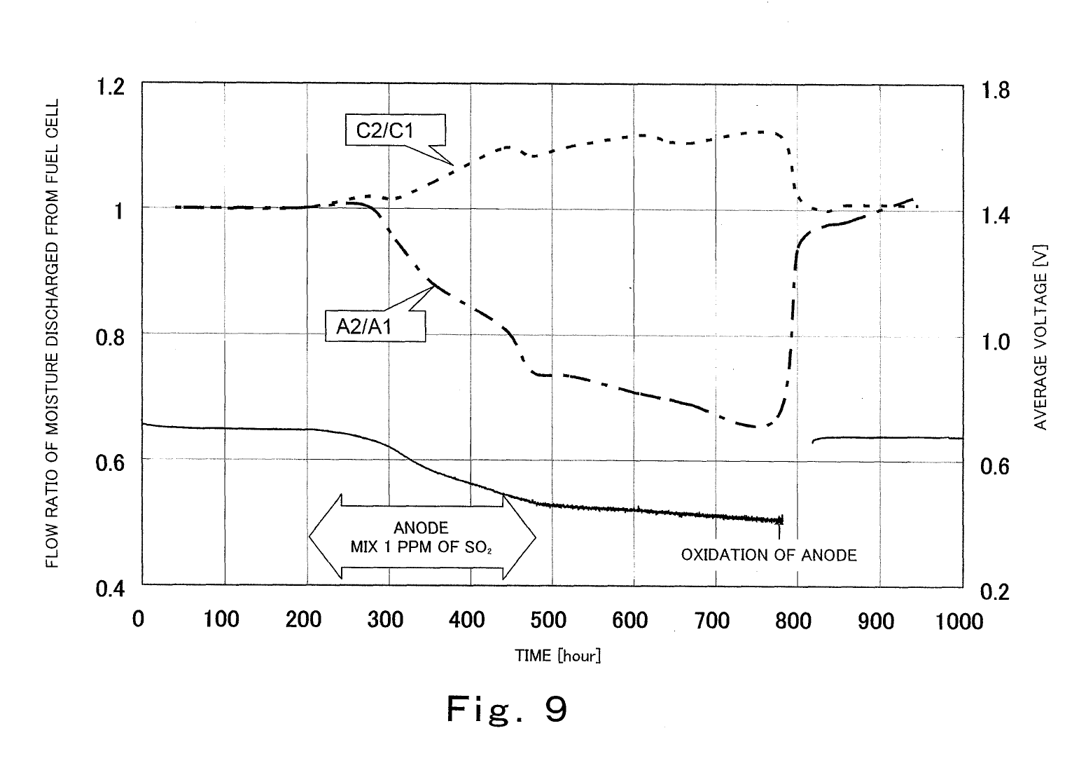

FIG. 9 is a graph showing time-lapse changes of the flow ratio of moisture discharged from the fuel cell and time-lapse changes of the average cell voltage at the time of the operation of the fuel cell system of Example 1. In FIG. 9, a dotted line denotes a flow ratio A2/A1, which is a ratio of the anode moisture flow rate (hereinafter referred to as “A2”), i.e., the flow rate of moisture discharged from the anode of the fuel cell 1, to the anode reference moisture flow rate (hereinafter referred to as “A1”). In addition, a dashed line in FIG. 9 denotes a flow ratio C2/C1, which is a ratio of the cathode moisture flow rate (hereinafter referred to as “C2”), i.e., the flow rate of moisture discharged from the cathode, to the cathode reference moisture flow rate (hereinafter referred to as “C1”). Further, in FIG. 9, a solid line denotes the average cell voltage of the fuel cell 1.

As shown in FIG. 9, when 1 ppm of SO₂ that was the impurity was mixed into the fuel gas, the anode 16a was poisoned, so that the flow ratio A2/A1 of moisture discharged from the anode 16a was decreased to 0.67. In contrast, the flow ratio C2/C1 of moisture discharged from the cathode 16b was increased to 1.12. The changes of the flow rate of moisture discharged from the fuel cell 1 continued even after the mixing of SO₂ in the anode 16a was stopped. The average voltage after the mixing of SO₂ was decreased gradually, and kept on decreasing even after the mixing of SO₂ was stopped.

When oxygen was introduced into the poisoned anode 16a of the fuel cell 1 to remove the impurity adsorbed to the anode 16a, the average voltage of the fuel cell 1 was restored, and accordingly, the flow ratio A2/A1 became substantially the same as that before the anode 16a was poisoned. Similarly, the flow ratio C2/C1 became substantially the same as that before the anode 16a was poisoned. Therefore, by measuring the changes of the flow rate of moisture discharged from the fuel cell 1, the poisoning of the anode 16a by the impurity could be detected, and the restoring of the performance of the fuel cell 1 by the oxidation of the anode 16a was confirmed.

### Comparative Example 1

In Comparative Example 1, a fuel cell system having the same configuration as the fuel cell system of Example 1 was operated by the reference output under the same operating condition as Example 1 except that SO₂ was mixed into the oxidizing gas to poison the cathode 16b.

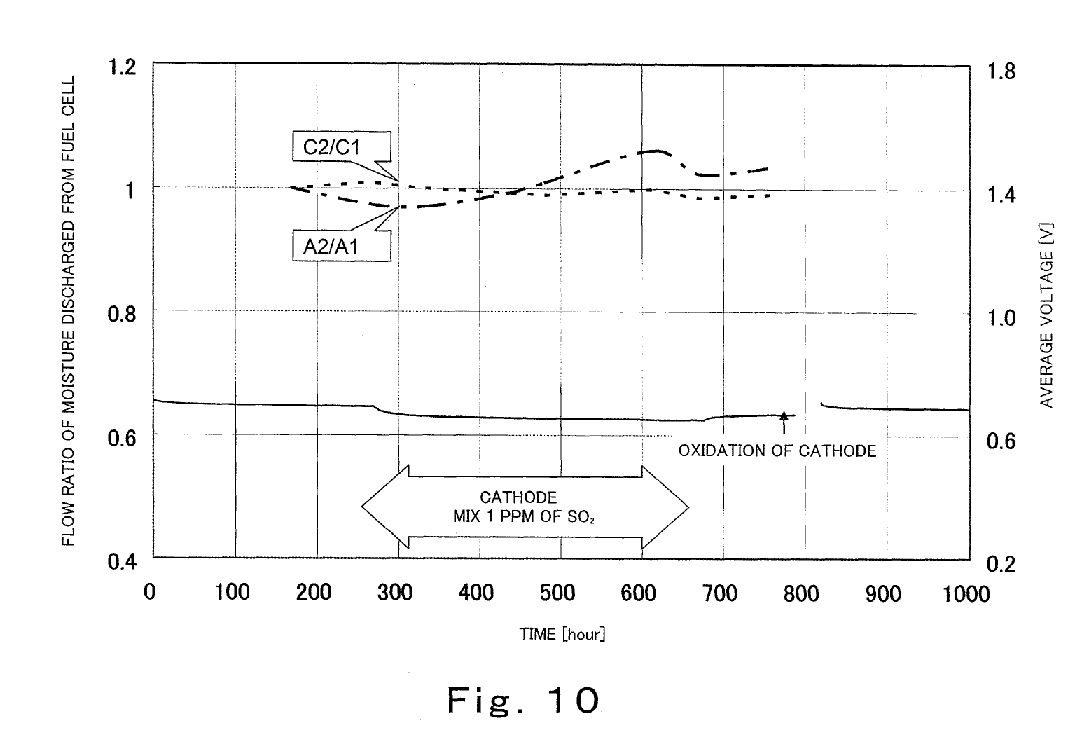

FIG. 10 is a graph showing time-lapse changes of the flow ratio of moisture discharged from the fuel cell and time-lapse changes of the average cell voltage during the operation of the fuel cell system of Comparative Example. In FIG. 10, a dotted line denotes the flow ratio A2/A1 that is a ratio of the anode moisture flow rate (hereinafter referred to as “A2”) that is the flow rate of moisture discharged from the anode 16a of the fuel cell 1 to the anode reference moisture flow rate (hereinafter referred to as “A1”), a dashed line denotes the flow ratio C2/C1 that is a ratio of the cathode moisture flow rate (hereinafter referred to as “C2”) that is the flow rate of moisture discharged from the cathode 16b to the cathode reference moisture flow rate (hereinafter referred to as “C1”), and a solid line denotes the average cell voltage of the fuel cell 1.

As shown in FIG. 10, the voltage of the cell was decreased by mixing 1 ppm of SO₂ to the oxidizing gas. However, the flow ratio C2/C1 of moisture discharged from the cathode 16b was in a range of 1±0.02, and the flow ratio A2/A1 of moisture discharged from the anode 16a was in a range of 1±0.03, that is, these flow ratios did not change so much. Moreover, the voltage of the cell was increased by carrying out the oxidation treatment of the cathode 16b. In FIG. 10, the flow rates of moisture discharged from the cathode 16b and the anode 16a after the oxidation of the cathode 16b were not measured. However, an experiment in which the cathode 16b was poisoned using the other poisoning material, and the oxidation treatment was carried out confirmed that both the flow ratio C2/C1 and the flow ratio A2/A1 did not change. Therefore, FIG. 10 indicates that both the flow ratio C2/C1 and the flow ratio A2/A1 do not change.

From the results of Example 1 and Comparative Example 1, in the fuel cell system and its operating method of the present invention, in a case where the anode was poisoned by the impurity, the flow ratio A2/A1 of moisture discharged from the anode of the fuel cell 1 was decreased, that is, the anode moisture flow rate became lower than the anode reference moisture flow rate, and the flow ratio C2/C1 of moisture discharged from the cathode was increased, that is, the cathode moisture flow rate became higher than the cathode reference moisture flow rate. Thereby, the poisoning of the anode by the impurity could be detected. With this, it was confirmed that it was possible to restore the performance of the fuel cell 1 by carrying out the oxidation treatment only when the anode was poisoned by the impurity, while minimizing the deterioration of the anode by the oxidation treatment.

It was thought that the flow ratio A2/A1 of moisture discharged from the anode 16a of the fuel cell 1 was decreased, and the flow ratio C2/C1 of moisture discharged from the cathode 16b was increased due to reasons below.

As described above, the fuel gas is supplied from the fuel gas supplying manifold hole 40A formed on the anode separator 31 of each cell 100, passes through the gas passage 41, and is discharged from the fuel gas discharging manifold 45A. Therefore, it is thought that the concentration of the hydrogen gas on the upstream side of the gas passage 41 (on a side closer to the fuel gas supplying manifold 40A) is higher than that on the downstream side, and degrees of the reactions shown by Chemical Formulas 1 and 2 at the gas diffusion electrode 16 are high (degree of the electric power generation distribution is high).

it is thought that in a case where the impurity is mixed into the fuel gas, it is thought that the concentration of the impurity contained in the fuel gas on the upstream side of the gas passage 41 is higher than that on the downstream side, and a portion of the anode 16a which contacts the upstream side of the gas passage 41 is poisoned more easily than a portion which contacts the downstream side.

Therefore, a place where the degree of the electric power generation distribution at the gas diffusion electrode 16 is high shifts from the upstream side of the gas passage 41 to its midstream side, and a portion of the gas diffusion electrode 16 which is associated with the electric power generation decreases. On this account, the amount of water which back-diffuses from the cathode 16b to the anode 16a decreases. As a result, it is thought that the flow rate of moisture discharged from the anode 16a of the fuel cell 1 decreases (the flow ratio A2/A1 of moisture decreases) as compared to the flow rate at the time of the reference output, and the flow rate of moisture discharged from the cathode 16b of the fuel cell 1 increases (the flow ratio C2/C1 of moisture increases) as compared to the flow rate at the time of the reference output.

Next, the range of the potential of the anode in the fuel cell system and its operating method of the present invention will be explained in reference to Example 2.

In Example 2, the unit cell 100 of the fuel cell of Example 1 was used again, the anode 16a was poisoned in the same manner as in Example 1, a 100RH % hydrogen gas was supplied to the cathode 16b at a rate of 300 ml/min, a 100RH % nitrogen gas was supplied to the anode 16a at a rate of 300 ml/min, and the cell 100 was maintained at a temperature of 65° C. Then, a bipolar cyclic voltammetry using the cathode 16b as a reference electrode and the anode 16a as a working electrode was carried out. The measuring method was to use the cathode 16b as the reference electrode (virtual standard hydrogen electrode), use the anode 16a as the working electrode, and sweep the potential of the anode 16a in a range from 0V to +1.2V using the cathode 16b as a reference. Specifically, a step of sweeping the potential of the anode 16a from 0V to +1.2V at a potential sweep rate of 10 mV/sec, inverting the direction of potential sweeping and sweeping the potential of the anode 16a from +1.2V to 0V at the same potential sweep rate was regarded as 1 cycle, and the current value (oxidation current value, reduction current value) by the oxidation-reduction reaction of the anode 16a was measured.

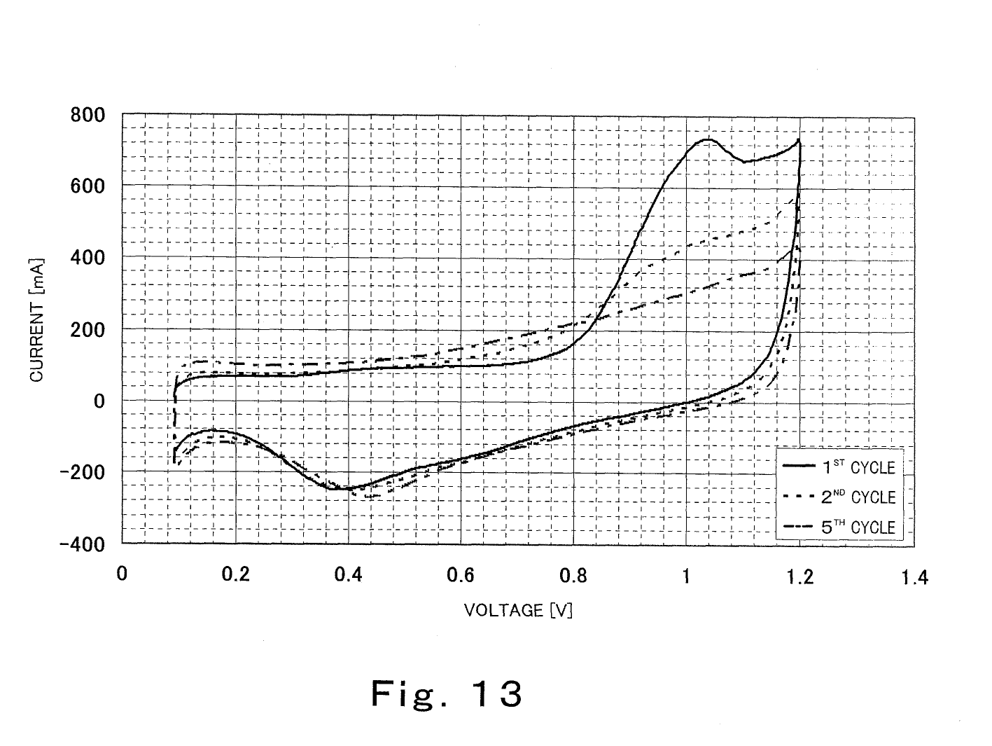

FIG. 13 is a graph on which current values by the oxidation-reduction reaction of the anode 16a in Example 2 are plotted. In FIG. 13, a solid line denotes a result of cyclic voltammogram of the 1^{st} cycle when the voltage application of the anode 16a was carried out, a dotted line denotes a result of the cyclic voltammogram of the 2^{nd} cycle, and a dashed line denotes a result of the cyclic voltammogram of the 5^{th} cycle.

As shown in FIG. 13, it was confirmed that the peak (between +0.8V to +1.2V) of the current value of the anode 16a measured immediately after the anode 16a was poisoned by SO₂ (1^{st} cycle) was decreased by sweeping the potential of the anode 16a (2^{nd} cycle or 5^{th} cycle), that is, by applying a voltage between the anode 16a and the cathode 16b, and SO₂ that was the impurity was oxidized and removed, so that the performance of the fuel cell 1 was restored.

As above, in Example 2, it was confirmed that the potential of the anode 16a was controlled to be +0.8V to +1.23V with respect to the standard hydrogen electrode, so that the impurity (SO₂ here) adhered to the anode 16a could be oxidized and removed. Moreover, in Example 2, it was confirmed that the impurity (poisoning component, such as carbon monoxide, to be adsorbed to the anode 16a) to be adhered to the anode 16a was adhered to the anode 16a in advance, a potential at which the impurity was electrochemically oxidized was obtained by the cyclic voltammetry, and the potential of the anode 16a was adjusted to be the obtained potential or more, so that the impurity adhered to the anode 16a could be oxidized and removed.

### INDUSTRIAL APPLICABILITY

Since the present invention can surely restore the performance of the anode at such a timing that the performance of the fuel cell needs to be restored, it is useful as a fuel cell system and its operating method each of which can easily restore the performance of the polymer electrolyte fuel cell while suppressing damages of the polymer electrolyte fuel cell.

1. A fuel cell system comprising:
a polymer electrolyte fuel cell configured to include an MEA having a polymer electrolyte membrane and an anode and a cathode which sandwich the polymer electrolyte membrane, to cause the anode to be supplied with a fuel gas and the cathode to be supplied with an oxidizing gas, to cause the supplied fuel gas and the supplied oxidizing gas to react to generate electric power, to discharge an unreacted fuel gas from the anode, and to discharge an unreacted oxidizing gas from the cathode;
a fuel gas supplying device which supplies the fuel gas to the anode;
an oxidizing gas supplying device which supplies the oxidizing gas to the cathode;
a moisture flow rate detector which detects at least one of a flow rate of moisture discharged from the cathode and a flow rate of moisture discharged from the anode (flow rate of moisture is hereinafter referred to as “moisture flow rate”);
storage means for storing a reference moisture flow rate that is the moisture flow rate at the time of a reference output of said polymer electrolyte fuel cell; and
an anode oxidizer which compares the moisture flow rate detected by said moisture flow rate detector with the reference moisture flow rate stored in said storage means and oxidizes the anode based on a result of the comparison.

2. The fuel cell system according to claim 1, wherein said anode oxidizer is configured to oxidize the anode in such a manner that said anode oxidizer controls a potential of the anode to be in a range from 0 to +1.23V with respect to a standard hydrogen electrode.

3. The fuel cell system according to claim 1, wherein said anode oxidizer is configured to oxidize the anode in such a manner that said anode oxidizer controls a potential of the anode to be in a range from +0.8 to +1.23V with respect to a standard hydrogen electrode.

4. The fuel cell system according to claim 1, wherein said anode oxidizer is configured to oxidize the anode in such a manner that said anode oxidizer controls a potential of the anode to be equal to or higher than a potential at which a poisoning component adsorbed to the anode is electrochemically oxidized.

5. The fuel cell system according to claim 1, wherein:
said moisture flow rate detector is a cathode moisture flow rate detector which detects a cathode moisture flow rate that is the flow rate of moisture discharged from the cathode;
said storage means stores a cathode reference moisture flow rate that is the flow rate of moisture discharged from the cathode at the time of the reference output; and
said anode oxidizer is configured to oxidize the anode in a case where the cathode moisture flow rate is higher than the cathode reference moisture flow rate.

6. The fuel cell system according to claim 1, wherein:
said moisture flow rate detector is an anode moisture flow rate detector which detects an anode moisture flow rate that is the flow rate of moisture discharged from the anode;
said storage means stores an anode reference moisture flow rate that is the flow rate of moisture discharged from the anode at the time of the reference output; and
said anode oxidizer is configured to oxidize the anode in a case where the anode moisture flow rate is lower than the anode reference moisture flow rate.

7. The fuel cell system according to claim 5, wherein the cathode moisture flow rate detector is configured to calculate a flow rate of steam from a dew point and flow rate of the oxidizing gas and to detect the cathode moisture flow rate from the calculated flow rate of the steam and a flow rate of water discharged from the cathode.

8. The fuel cell system according to claim 6, wherein the anode moisture flow rate detector is configured to calculate a flow rate of steam from a dew point and flow rate of the oxidizing fuel gas and to detect the anode moisture flow rate from the calculated flow rate of the steam and a flow rate of water discharged from the anode.

9. The fuel cell system according to claim 5, wherein the cathode moisture flow rate detector is configured to change moisture, discharged from the cathode, into water to detect the cathode moisture flow rate.

10. The fuel cell system according to claim 6, wherein the anode moisture flow rate detector is configured to change moisture, discharged from the anode, into water to detect the anode moisture flow rate.

11. The fuel cell system according to claim 5, wherein the cathode moisture flow rate detector is configured to change moisture, discharged from the cathode, into steam to detect the cathode moisture flow rate.

12. The fuel cell system according to claim 6, wherein the anode moisture flow rate detector is configured to change moisture, discharged from the anode, into steam to detect the anode moisture flow rate.

13. The fuel cell system according to claim 1, wherein said anode oxidizer is configured to oxidize the anode in such a manner that said anode oxidizer controls to temporarily decrease a flow rate of the fuel gas supplied from said fuel gas supplying device to the anode, to increase a potential of the anode.

14. The fuel cell system according to claim 1, wherein:
said anode oxidizer includes a mixture gas supplying unit for mixing a mixture gas into the fuel gas to be supplied to the anode; and
said anode oxidizer is configured to oxidize the anode in such a manner that said anode oxidizer controls the mixture gas supplying unit to mix the mixture gas into the fuel gas, thereby temporarily decreasing a concentration of a hydrogen gas contained in a gas to be supplied to the anode to increase a potential of the anode.

15. The fuel cell system according to claim 1, further comprising an electric output device for adjusting an output of said polymer electrolyte fuel cell, wherein
said anode oxidizer is configured to oxidize the anode in such a manner that said anode oxidizer controls to maintain a constant flow rate of the fuel gas to be supplied to the anode and increase an output current density of the electric output device, thereby increasing a potential of the anode.

16. The fuel cell system according to claim 1, wherein:
said anode oxidizer includes an air supplying unit which supplies air to the anode; and
said anode oxidizer is configured to oxidize the anode in such a manner that said anode oxidizer controls the air supplying unit to supply the air to the anode, thereby increasing a potential of the anode.

17. A method for operating a fuel cell system including: a polymer electrolyte fuel cell configured to include an MEA having a polymer electrolyte membrane and an anode and a cathode which sandwich the polymer electrolyte membrane, to cause the anode to be supplied with a fuel gas and the cathode to be supplied with an oxidizing gas, to cause the supplied fuel gas and the supplied oxidizing gas to react to generate electric power, to discharge an unreacted fuel gas from the anode, and to discharge an unreacted oxidizing gas from the cathode; a fuel gas supplying device which supplies the fuel gas to the anode; an oxidizing gas supplying device which supplies the oxidizing gas to the cathode; a moisture flow rate detector which detects at least one of a flow rate of moisture discharged from the cathode or a flow rate of moisture discharged from the anode (flow rate of moisture is hereinafter referred to as “moisture flow rate”); and storage means for storing a reference moisture flow rate that is the moisture flow rate at the time of a reference output of the polymer electrolyte fuel cell,
the method comprising the steps of:
comparing the moisture flow rate detected by the moisture flow rate detector with the reference moisture flow rate stored in the storage means and oxidizing the anode based on a result of the comparison.

18. The method according to claim 17, further comprising the step of oxidizing the anode in a state in which a potential of the anode is in a range from 0 to +1.23V with respect to a standard hydrogen electrode.

19. The method according to claim 17, further comprising the step of oxidizing the anode in a state in which a potential of the anode is in a range from +0.8 to +1.23V with respect to a standard hydrogen electrode.

20. The method according to claim 17, further comprising the step of oxidizing the anode in a state in which a potential of the anode is equal to or higher than a potential at which a poisoning component adsorbed to the anode is electrochemically oxidized.

21. The method according to claim 17, wherein:
the moisture flow rate detector is a cathode moisture flow rate detector which detects a cathode moisture flow rate that is the flow rate of moisture discharged from the cathode; and
the storage means stores a cathode reference moisture flow rate that is the flow rate of moisture discharged from the cathode at the time of the reference output,
the method further comprising the step of oxidizing the anode in a case where the cathode moisture flow rate is higher than the cathode reference moisture flow rate.

22. The method according to claim 17, wherein:
the moisture flow rate detector is an anode moisture flow rate detector which detects an anode moisture flow rate that is the flow rate of moisture discharged from the anode; and
the storage means stores an anode reference moisture flow rate that is the flow rate of moisture discharged from the anode at the time of the reference output,
the method further comprising the step of oxidizing the anode in a case where the anode moisture flow rate is lower than the anode reference moisture flow rate.

23. The method according to claim 17, further comprising the step of oxidizing the anode by temporarily decreasing the fuel gas, supplied from the fuel gas supplying device to the anode, to increase a potential of the anode.

24. The method according to claim 17, wherein the fuel cell system further includes a mixture gas supplying unit for mixing a mixture gas into the fuel gas to be supplied to the anode,
the method further comprising the step of oxidizing the anode by mixing the mixture gas into the fuel gas to temporarily decrease a concentration of a hydrogen gas contained in a gas to be supplied to the anode, thereby increasing a potential of the anode.

25. The method according to claim 17, wherein the fuel cell system further includes an electric output device for adjusting an output of the polymer electrolyte fuel cell,
the method further comprising the step of oxidizing the anode by maintaining a constant flow rate of the fuel gas to be supplied to the anode and increasing an output current density of the electric output device, thereby increasing a potential of the anode.

26. The method according to claim 17, wherein the fuel cell system further includes an air supplying unit which supplies air to the anode,
the method further comprising the step of oxidizing the anode by supplying the air from the air supplying device to the anode, thereby increasing a potential of the anode.
